(19) United States
(12) Patent Application Publication
(10) Pub. No.: US 2014/0003939 A1
(43) Pub. Date: Jan. 2, 2014

(54) LOAD SHAPE CONTROL OF WIND TURBINES

(71) Applicants: Douglas E. Adams, West Lafayette, IN (US); Joseph Yutzy, South Bend, IN (US); Scott R. Dana, Lafayette, IN (US)

(72) Inventors: Douglas E. Adams, West Lafayette, IN (US); Joseph Yutzy, South Bend, IN (US); Scott R. Dana, Lafayette, IN (US)

(73) Assignee: PURDUE RESEARCH FOUNDATION, West Lafayette, IN (US)

(21) Appl. No.: 14/005,157

(22) PCT Filed: Mar. 15, 2012
(86) PCT No.: PCT/US2012/029254

§ 371 Date: Sep. 13, 2013

Related U.S. Application Data
(60) Provisional application No. 61/452,891, filed on Mar. 15, 2011.

(51) Int. Cl. F03D 7/04

(52) U.S. Cl. CPC F03D 7/045
USPC 416/1

(57) ABSTRACT

Methods and apparatus for control and monitoring of wind turbines. Various embodiments pertain to the operational analysis of vibratory modes of the blades of the wind turbine. This real time analysis of blade modal response can be used as feedback in a control system to change the yaw angle of the hub and nacelle to capture higher power from the wind stream, change the pitch on one or more blades to reduce uneven blade loading, to identify damage to a blade, and further to identify the accumulation of ice on a blade.

### CROSS REFERENCE TO RELATED APPLICATION

This application claims the benefit of priority to U.S. Provisional Patent Application Ser. No. 61/452,891, filed Mar. 15, 2011, entitled LOAD SHAPE CONTROL OF WIND TURBINES, incorporated herein by reference.

### GOVERNMENT RIGHTS

This invention was made with government support under DE-EE0003265 awarded by the U.S. Department of Energy. The government has certain rights in the invention.

### BACKGROUND

Wind farm owners and operators would benefit from knowing the dynamic performance of each wind turbine rotor given the local wind state. If the wind loading of each wind turbine could be ascertained, the maintenance, operation, and control of that turbine could be tailored to maximize uptime (mean time between inspections) and potentially better tracking of the optimal tip speed ratio for maximum energy capture (capacity). For example, wind farm operators could compare stored historical loads estimates of an individual turbine, particularly severe loads, to the assumed design loads to schedule condition-based maintenance for that turbine. In addition, operators could temporarily suppress loads that are primarily responsible for causing the growth of fatigue damage to allow for parts to be ordered in a timely manner (performance-based logistics).

Inflow wind characteristics are currently gathered from anemometers and wind vanes located on the nacelle behind the rotor disk. This position does not lead to an awareness of the inflow due to interference from the rotor blades and nacelle. Wind direction data gathered at this location is used to control yaw position, but this data does not capture real-time wind events. A more accurate measurement of the inflow would allow for more advanced control algorithms to increase energy capture. In particular, increased power production could be achieved using precision yaw control systems. Furthermore, the force distribution on the rotor is of interest from an energy production point of view and the current measurements may provide a perspective of the wind state. Because wind turbines often operate between the cut-in and rated wind speeds, leading to less generated power than their nameplate rating, room for improvement exists to increase power output towards their maximum capability.

Turbines often suffer from yaw error, or a lack of perpendicularity to the oncoming wind flow. Yaw error leads to a decrease of energy capture and subjects the turbine to large fatigue loads. Improper yaw alignment has been shown to create a local rotor blade angle of attack near stall. The addition of tower shadow effects and the cyclic separation and reattachment of flow over the rotor blades create large aerodynamic loads beyond static stall values. Yaw position errors can be contributed to several factors such as hysteresis in drive components, improper yaw sensor mesh, development of backlash in yaw position sensors and long time constants between sensor responses and drive action. Yaw error is almost unavoidable if winds have high directional variance, but an increase in yaw response can improve energy capture by decreasing the time constant of traditional methods. The development of an active yaw control algorithm has been explored using the maximum generated power as a means to determine maximum wind speed direction based on a Hill Climbing Control (HCC) program. This method relied on continuous changes in yaw angle resulting in large time constants for correct perpendicular yaw alignment and an inability to align in non steady state wind flow. One new method uses a Laser Wind Sensor for 3D mapping of the inflow (FIG. 5). These systems focus on the wind state and do not directly identify the loads experience by the rotor.

Modern utility-scale wind turbines are equipped with several types of sensors for monitoring the wind resource as well as mechanical and electrical variables of interest in the turbine. The performance and reliability of wind turbines are largely governed by the nature of the wind loads that act on the turbine rotor blades. The ability to characterize these loads in real time is advantageous for implementing control algorithms that increase energy capture, which is the primary short-term measure of wind turbine performance. An equally important measure of performance is long-term wind turbine reliability. Reliability is related to the structural integrity of the blade root, low speed shaft, yaw joint, and other load bearing components. A more complete awareness of the temporal and spatial variations in the wind loads that act upon the turbine rotor would allow operators to implement advanced control and maintenance strategies. Such information could also provide an understanding of why similar turbines in the same wind farm experience different failure patterns. Various embodiments of the present invention pertain to how the rotor forced response changes due to yaw and pitch set-point errors and how these changes affect the sensitivity of blade measurements to damage mechanisms. This understanding can be applied to improve energy capture while simultaneously facilitating turbine health management. Utility-scale wind turbines are equipped with anemometers and wind vanes that are located on the nacelle behind the rotor disk to characterize inflow wind conditions. However, this measurement position is not ideal for sensing wind speed due to interference that is created by the blades and nacelle. Furthermore, the wind speed often varies across the rotor disk due to vertical and horizontal wind shear, as a result of the atmospheric boundary layer and other phenomena such as wake flow, but cup anemometers and wind vanes are incapable of measuring these variations. Wind direction data that is gathered by these sensors is used in part to control the yaw position, but this data yields an incomplete perspective of the force distribution on the rotor, which is of most interest for increasing energy capture and monitoring the structural integrity of the turbine.

Because of these sensor errors, turbines often suffer from a lack of perpendicularity to the oncoming wind flow; this is known as yaw error. This condition leads to a decrease in energy capture and large fatigue loads on the turbine. Improper yaw alignment has been shown to create a local rotor blade angle of attack near stall. The addition of tower shadow effects and the cyclic separation and reattachment of flow over the rotor blades create large aerodynamic loads beyond static stall values. The source of yaw control errors can be contributed to several different factors such as hysteresis in drive components, improper yaw sensor mesh, development of backlash in yaw position sensors and long time constants between sensor responses and drive action. Wind turbines can experience yaw error routinely due to the dynamic nature of the wind as it continuously changes direction. If winds have high directional variance, yaw error is almost unavoidable especially on short time scales; however, a small increase in yaw response time could significantly improve energy capture by decreasing the turbine response time constant to variations in wind direction.

The development of an active yaw control algorithm has been explored in the literature using the maximum generated power as a means of determining the maximum wind speed direction based on a Hill Climbing Control (HCC) program. This method relies on continuous changes in yaw angle resulting in large time constants for correct perpendicular yaw alignment and an inability to align in non steady state wind flow. Other methods utilize costly Doppler LIDAR (Light Detection And Ranging) systems, which apply lasers for three-dimensional mapping of the wind inflow to a turbine. These systems focus on the wind state and do not identify the loads experienced by the rotor blades.

In addition to yaw control errors, wind turbines can also suffer from pitch control errors. The use of active pitch control is common for power regulation. A pitch controlled wind turbine uses the power output of the generator to determine the useful for pitch action. When power output increases beyond the rated capacity of the turbine's generator, a command is sent from the Supervisory Command And Data Acquisition (SCADA) system to the blade pitch mechanism to immediately turn (pitch) the rotor blades out of the wind. Conversely, as power output drops (i.e. wind speed decreases) the blades are turned back into the wind. This turning action along the longitudinal axis (pitch axis) is controlled by an electronic or hydraulic pitch motor and gear system. Generally, blades are pitched a few degrees every time the wind changes in order to maintain the optimum angle of attack to maximize the power output for all wind speeds. There are also active stall controlled and passive stall controlled wind turbines with different mechanisms for manipulating the blade pitch set point.

Pitch control is the predominant means of control in current utility-scale wind turbines and is sensitive to power output. A change in pitch angle (on the order of 2 degrees of less) has an impact on the performance and health of a wind turbine. The sensitivity to turbine performance is well illustrated by Burton 2001. The sources of pitch error are similar to those for yaw error and include hysteresis in pitch drive components, development of backlash in pitch position sensors and improper installation of the rotor blade in the field.

Power deficits, however, are not solely the result of incorrectly pitched blades. Yaw error, pitch error, rotor or drivetrain damage, and wind and weather conditions can all lead to reduced power levels. FIG. 1-1 demonstrates this result in a 1 kW horizontal axis wind turbine. Note that for normalized power output in the range of 70% and above, the reduction from 100% power can be due to either pitch error or yaw error. In order to distinguish between the two, various embodiment of the present invention utilize the blade dynamic response rather than relying on point measurements of wind speed, wind direction, and generator power for yaw and pitch control. In addition to being able to more precisely determine the wind loading conditions on the blades, structural dynamic analysis can be applied to monitor the health of the turbine components.

Another reliability concern for wind turbine rotor blades is blade ice accretion. As the number of wind turbines installed in cold weather climates or regions with cold and wet winters increases, blade ice accretion becomes a major reliability concern. Winter often brings the most favorable wind conditions, but downtime due to blade icing or related damage due to blade icing must be avoided. Without effective ice detection and removal, wind turbines can suffer power reductions as high as 30% per year. In addition to the economic loss, blade icing increases the wind loading experienced by the rotor blade due to a decrease in aerodynamic performance and rotor imbalance that can severely affect the drivetrain. An equally important concern of ice accretion is ice throw. As ice accumulates on the rotor blade in operation, shear and centrifugal forces act on the amassed ice, eventually leading to ice throw. It is most critical to detect ice accretion when the turbine is operating in an idle-speed condition. Here, the aerodynamic and centrifugal forces are small, as the rotational speed of the turbine is near zero. This permits the leading edge of the rotor blade to accumulate more ice at the stagnation point of the airfoil. When wind conditions become favorable for power production the rotational speed increases, the angle of attack changes and large masses of ice are shed. Ice throw fragments up to 16 inches in length and weighing up to two pounds have been recorded over 300 feet from the nearest wind turbine. Ice throw of this magnitude can pose a risk to civil structures and human life.

There are currently no standard solutions on the market for reliable ice detection that can be used as a control input for the turbine's supervisory system. Some measures to prevent icing have been successfully used and deicing methods are in development. However, not all methods operate continuously and there is a need for reliable ice detection to facilitate the activation of the deicing system. Various sensors have been tested but have not performed satisfactorily. There are four methods used for ice detection, but with limitations: 1) Infrared spectroscopy is limited to monitoring one section of the blade and requires the installation of fiber optic cables in the blade; 2) a flexible resonating diaphragm was shown to be effective but requires installation at multiple points inside the blade; 3) ultrasound has been proven effective at detecting ice on aircraft but has not been implemented in wind turbine blades and is not well suited for retro-fitting; 4) a change in capacitance was also measured using wires mounted in the surface of the blade.

What is needed are new methods and apparatus that improve the control of wind turbines. Various embodiments of the present invention do this in novel and unobvious ways.

### SUMMARY OF THE INVENTION

One aspect of the present invention pertains to a method for control of a wind turbine. Some embodiments include providing a wind turbine including a plurality of blades. Other embodiments include a plurality of sensors, each blade having at least one sensor. Yet other embodiments include observing the signals during operation of the wind turbine. Still others include determining a modal response of at least one blade; and modifying operation of the wind turbine at least in part to change the modal response.

Another aspect of the present invention pertains to a method for control of a wind turbine with blades. Some embodiments include providing a control system for the wind turbine and a sensor attached to at least one of the blades, the sensor providing a signal corresponding to the response of the blade. Other embodiments include reading the signal during operation of the wind turbine. Yet other embodiments include removing the mean value of the signal. Still other embodiments include identifying a blade vibratory mode from the signal; and preparing a variable for the control system and using the variable in control of the wind turbine, the value of the variable being at least partly dependent upon a characteristic of the vibratory mode.

Yet another aspect of the present invention pertains to a method for control of a wind turbine with a non-rotating structure and blades. Some embodiments include providing a control system for the wind turbine, a first sensor on a blade and providing a first signal corresponding to the response of the blade, and a second sensor attached to non-rotating structure of the wind turbine and providing a second signal corresponding to the response of the non-rotating structure. Other embodiments include measuring the first signal and the second signal during operation of the wind turbine. Yet other embodiments include cross-correlating the first signal and the second signal; and preparing a variable for use in the control system, the value of the variable being at least partly dependent upon cross-correlating.

Still another aspect of the present invention pertains to a method for control of a wind turbine having a plurality of blades. Some embodiments include providing a control system for the wind turbine, a sensor attached to each blade and providing a signal corresponding to the response of the blade. Other embodiments include converting into the frequency domain each of the plurality of signals. Yet other embodiments include comparing the frequency content of each blade to the frequency content of each other blade, and automatically controlling the wind turbine based on comparing.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary

### BRIEF DESCRIPTION OF THE DRAWINGS

FIG. 1 is an illustration of methodology for an online system identification of multiple-input multiple-output wind turbine model in the context of an offshore wind farm.

FIG. 2(a) is a photograph of a Micon 65/13 wind turbine with a sensored rotor blade mounted.

FIG. 2(b) is a photograph of the testing of a wind turbine rotor blade using modal impact measurements.

FIG. 3(a) is a graphical representation of wind speed in turbine axis direction over 180 minute period.

FIG. 3(b) is a graphical representation of an autopower spectra of wind speed using 50% overlap processing and Hanning window for 180 minute period.

FIG. 4(a) is a graphical representation of autopower spectra of 8m blade flap acceleration using 50% overlap processing and Hanning window for 180 min period.

FIG. 4(b) is a graphical representation of corresponding frequency response function magnitudes using along wind speed for shorter period of time.

FIG. 5 is a photo of a Vindicator® LWS installed upturbine.

FIG. 6 is a photograph showing a 2 m diameter wind turbine apparatus for generating controlled wind states and measuring the dynamic response of the rotor.

FIG. 7 shows rotor input and output measurement degrees of freedom in addition to wirelessly transmitted data acquisition hardware.

FIG. 8 shows a rotor mounted data acquisition system, battery power supply, and wireless transmitter.

FIG. 9 is a graphical representation of a complex mode indicator function identifying multiple repeated roots at several resonant frequencies.

FIG. 10 is a graphical representation of summed spectra of the 3 flap-direction accelerations at various yaw angles.

FIG. 11 shows turbine voltage output and its dependency on yaw angle.

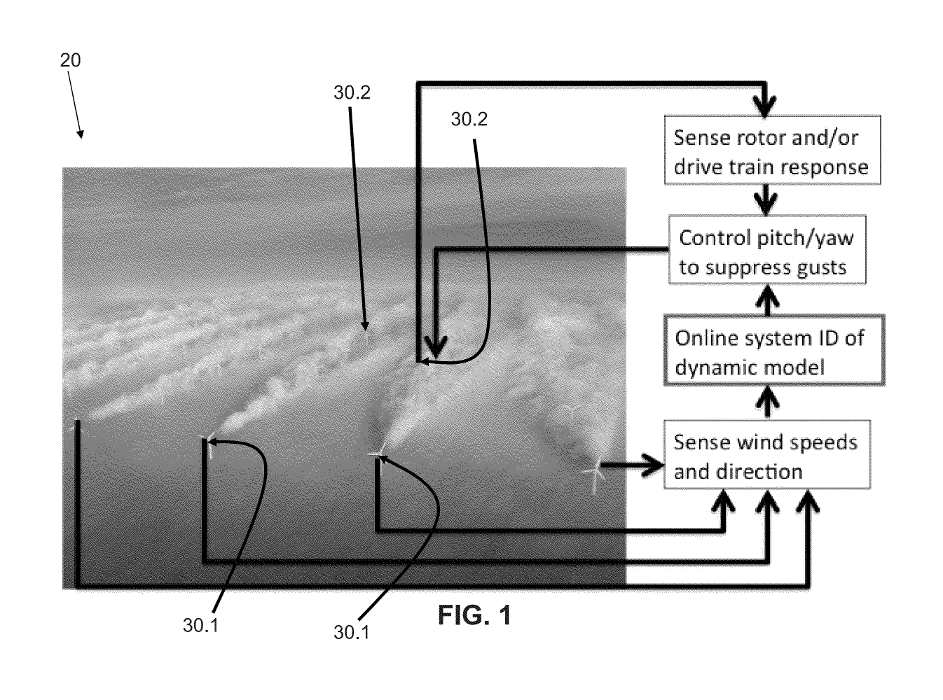

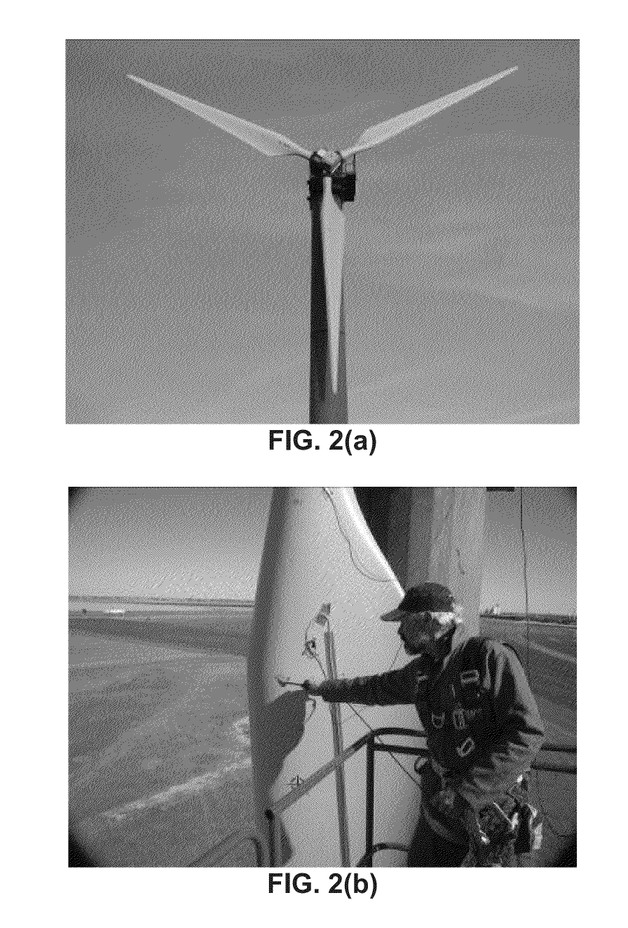

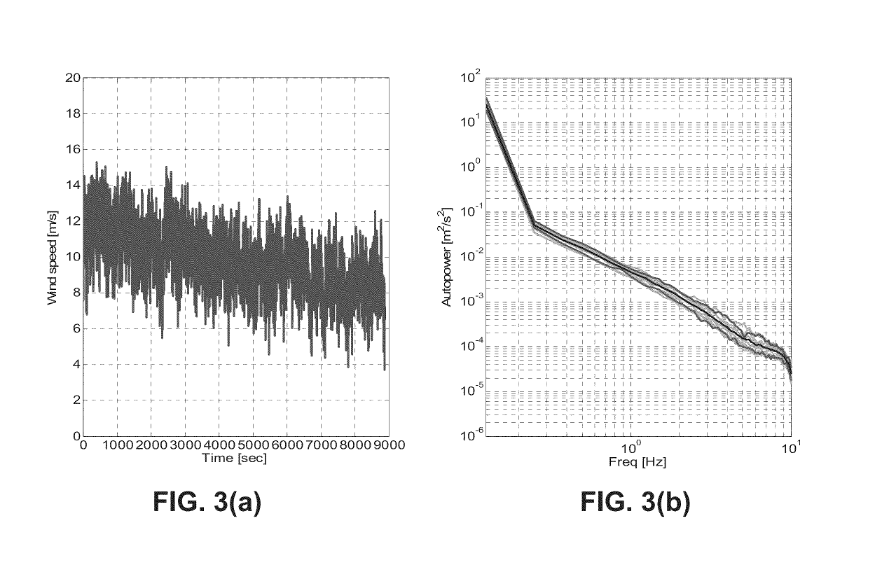

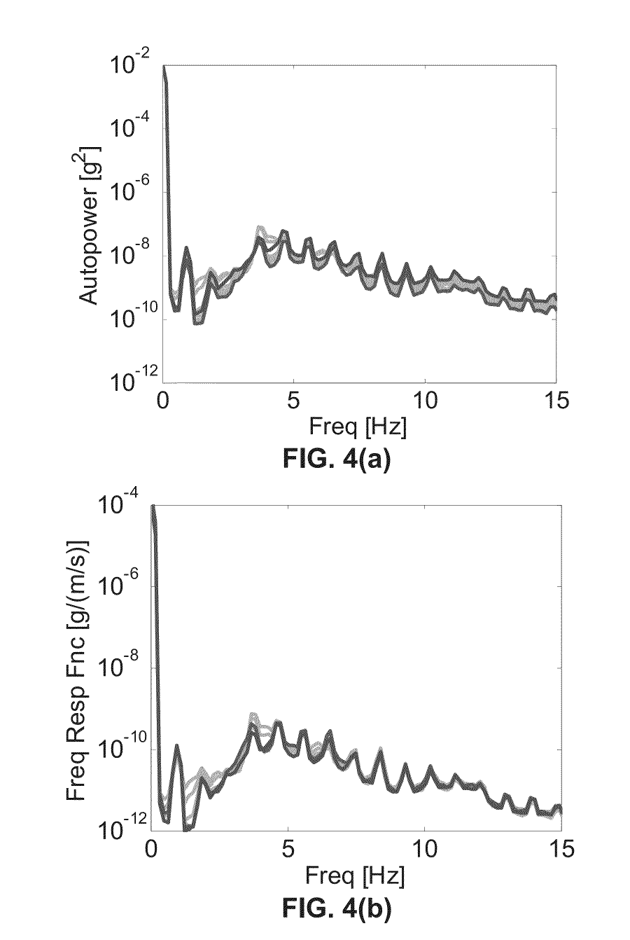

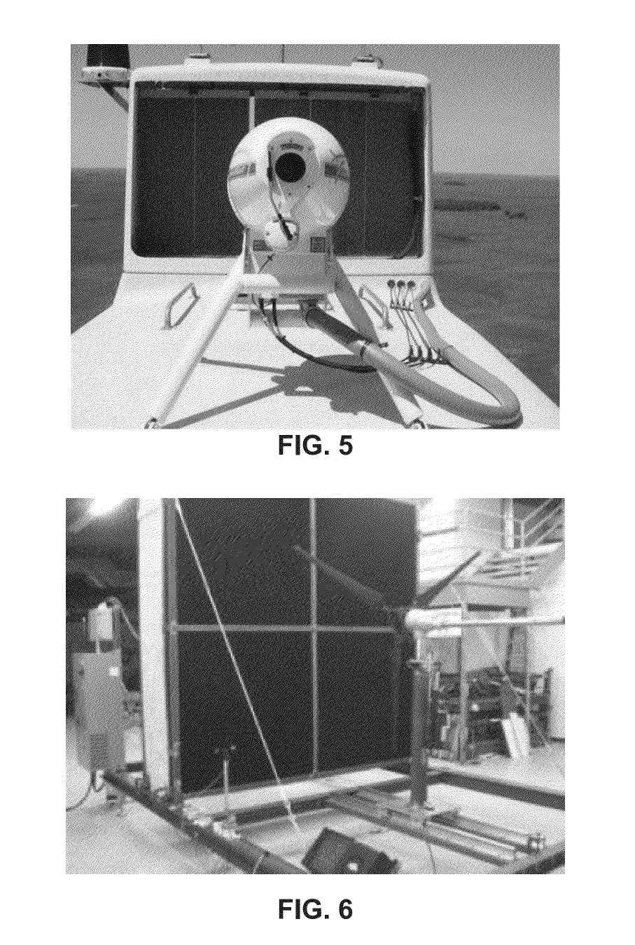

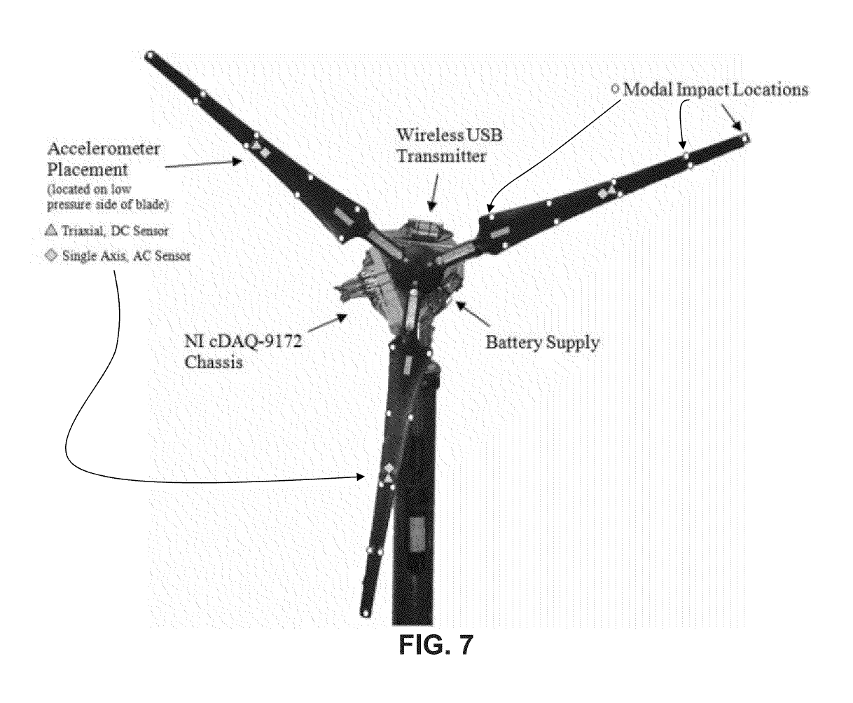

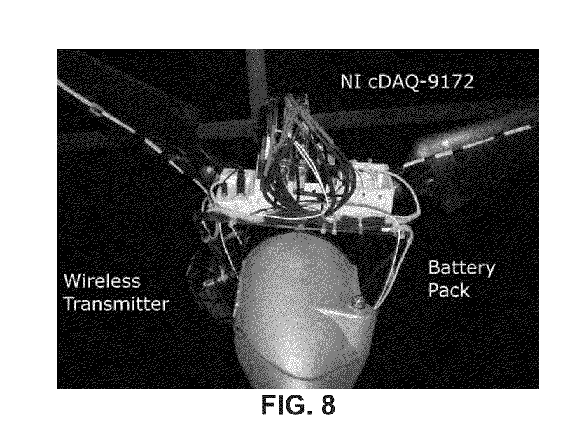

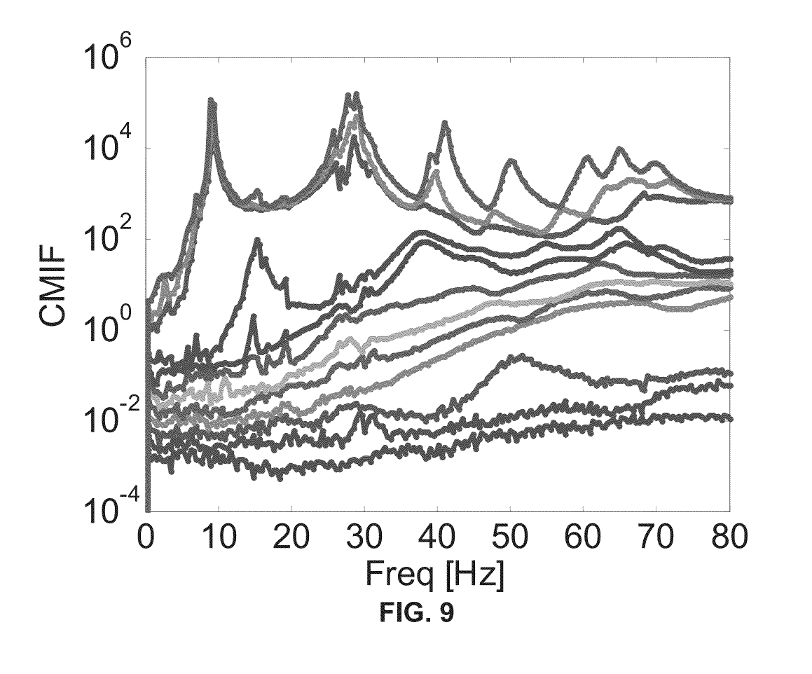

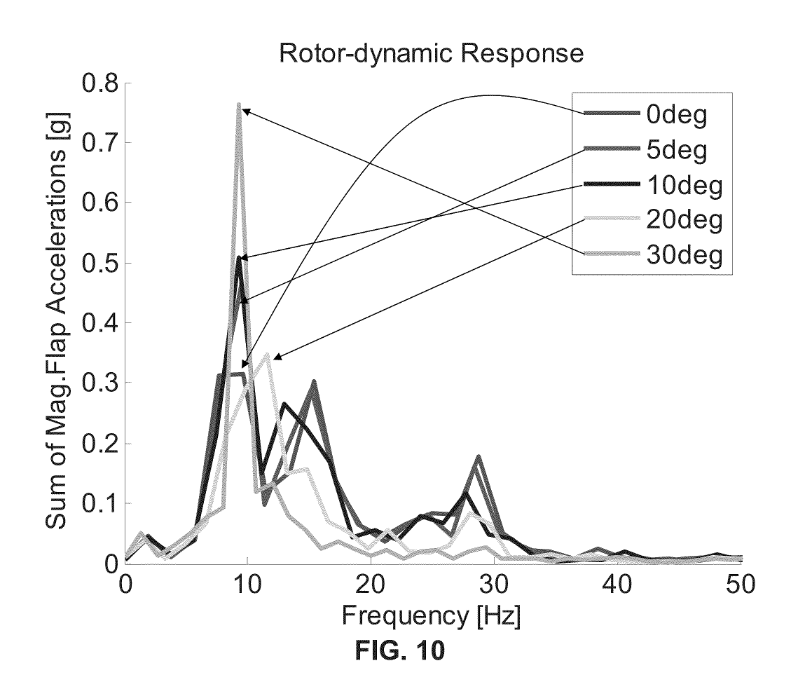

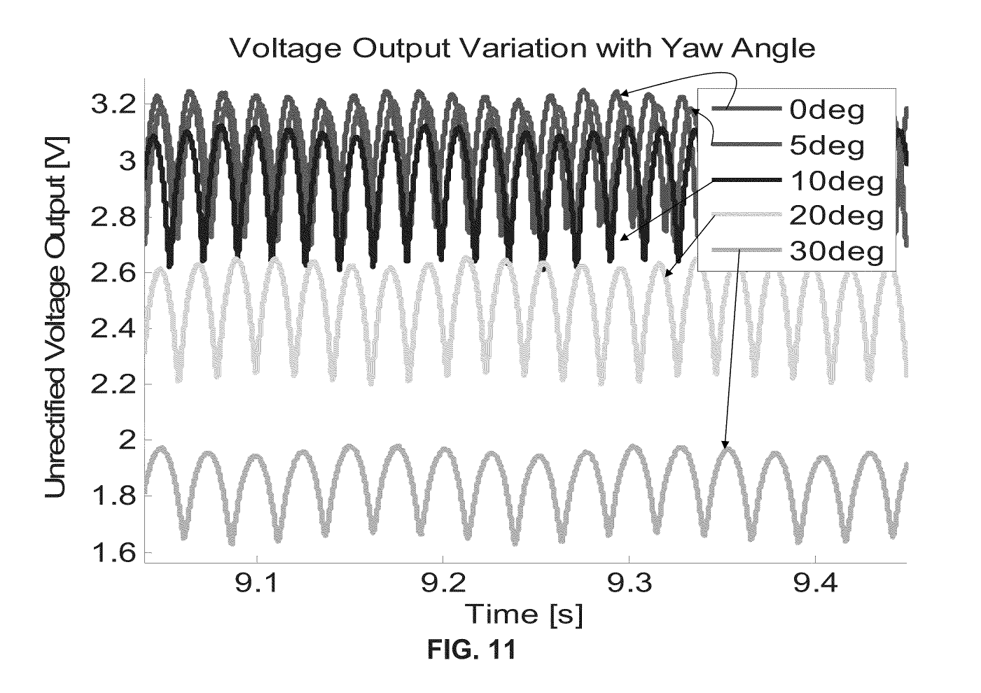

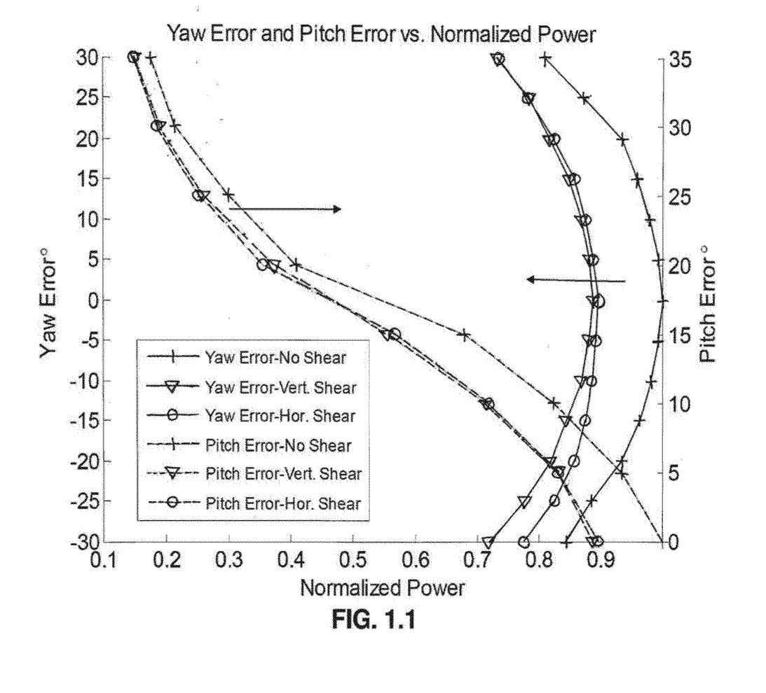

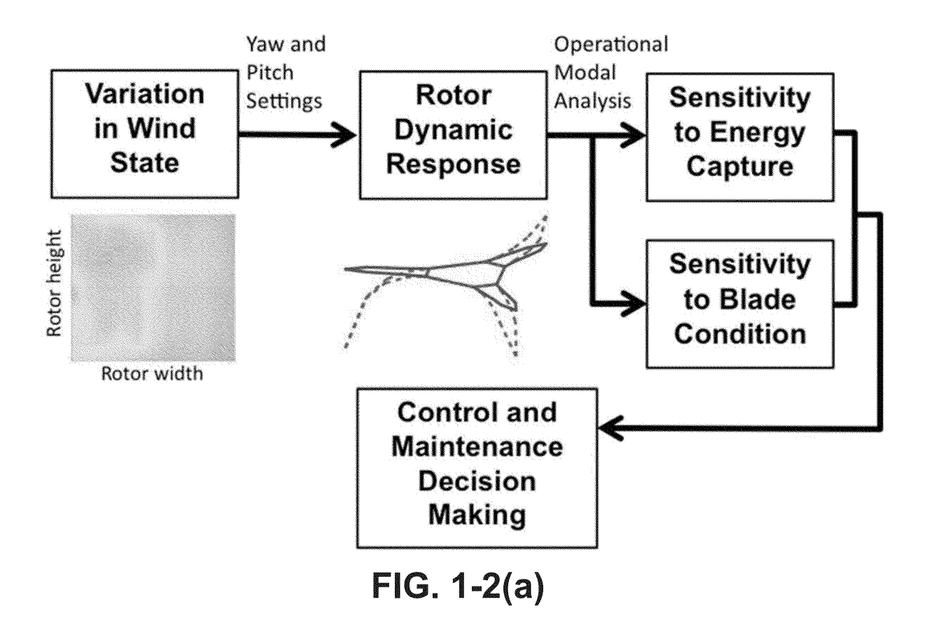

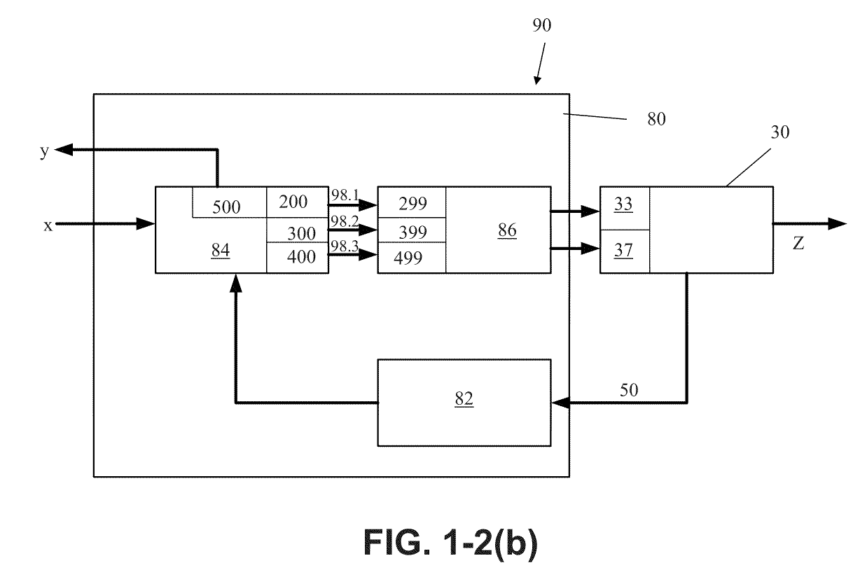

FIG. 1-1 is a graphical representation of experimental wind turbine yaw and pitch error vs. normalized generator power output.

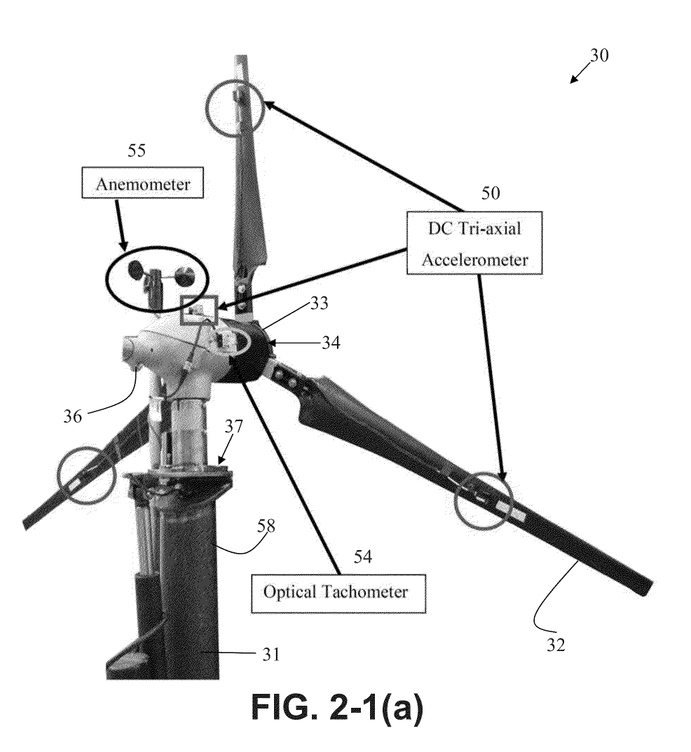

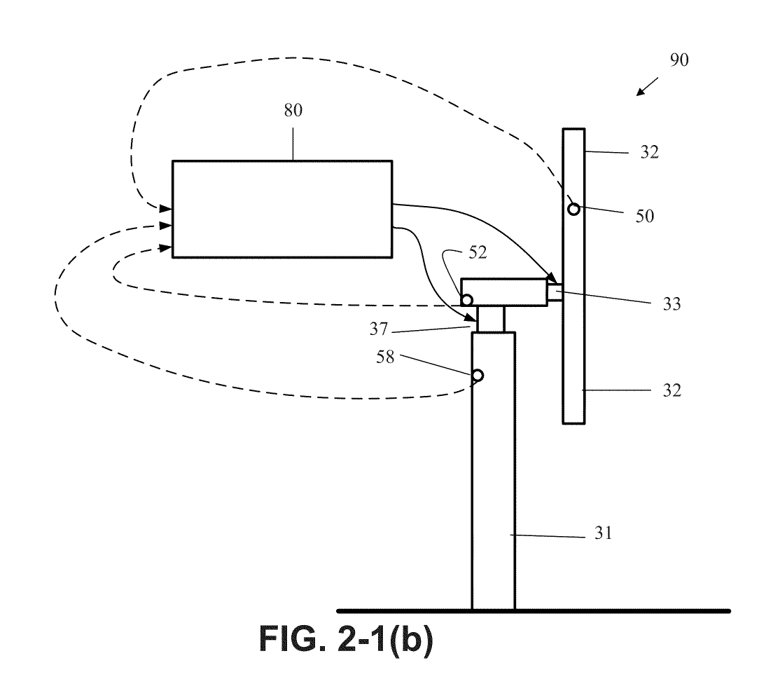

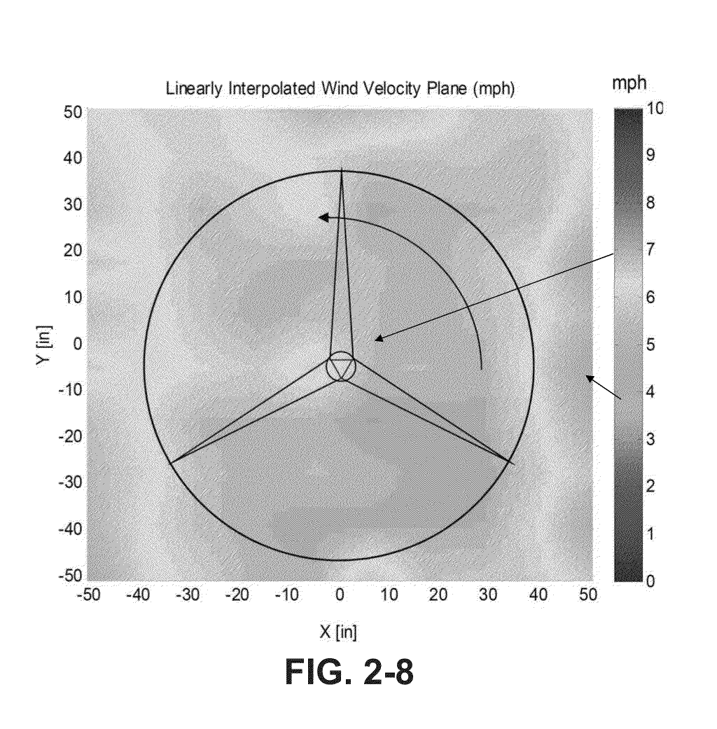

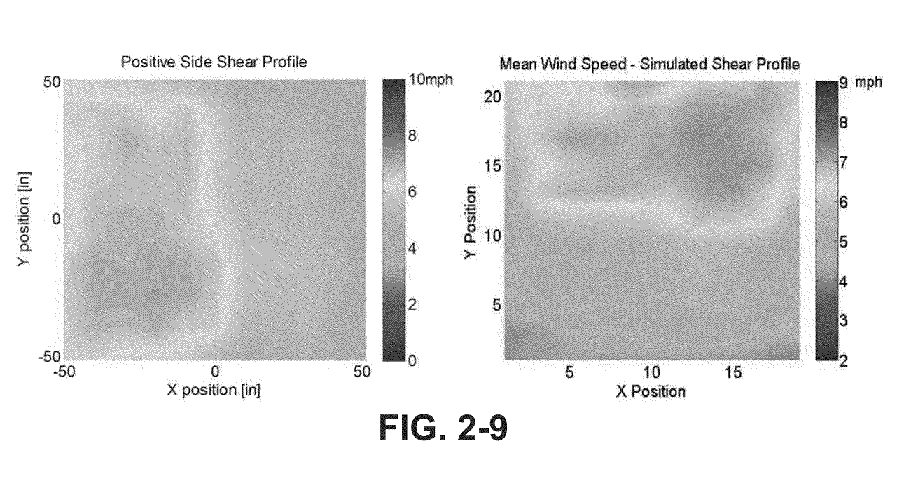

FIG. 1-2(a) is block diagram representation pertaining to the identification and use of rotor structural response for control and maintenance decision-making according to one embodiment of the present invention.

FIG. 1-2(b) shows a block diagram of a control system according to one embodiment of the present invention.

FIG. 2-1(a) is a photograph of a portion of a wind turbine according to one embodiment of the present invention.

FIG. 2-1(b) is a schematic representation of a wind turbine system according to one embodiment of the present invention.

FIG. 2-8: Measured wind profile for the uniform wind condition at 35 Hz fan speed.

FIG. 2-9: Measured wind profile for the side (horizontal) shear condition and the vertical shear condition at 35 Hz fan speed.

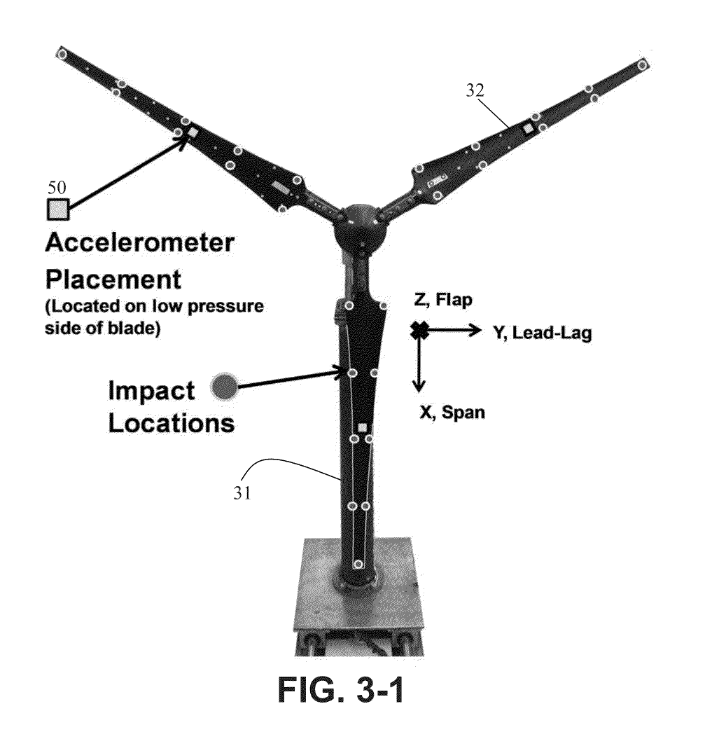

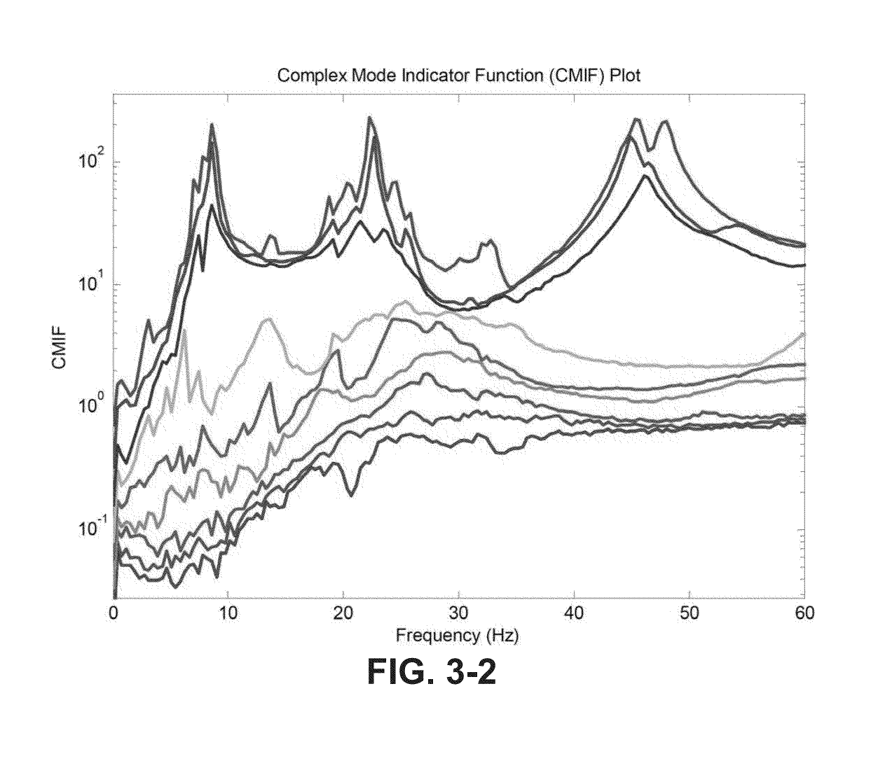

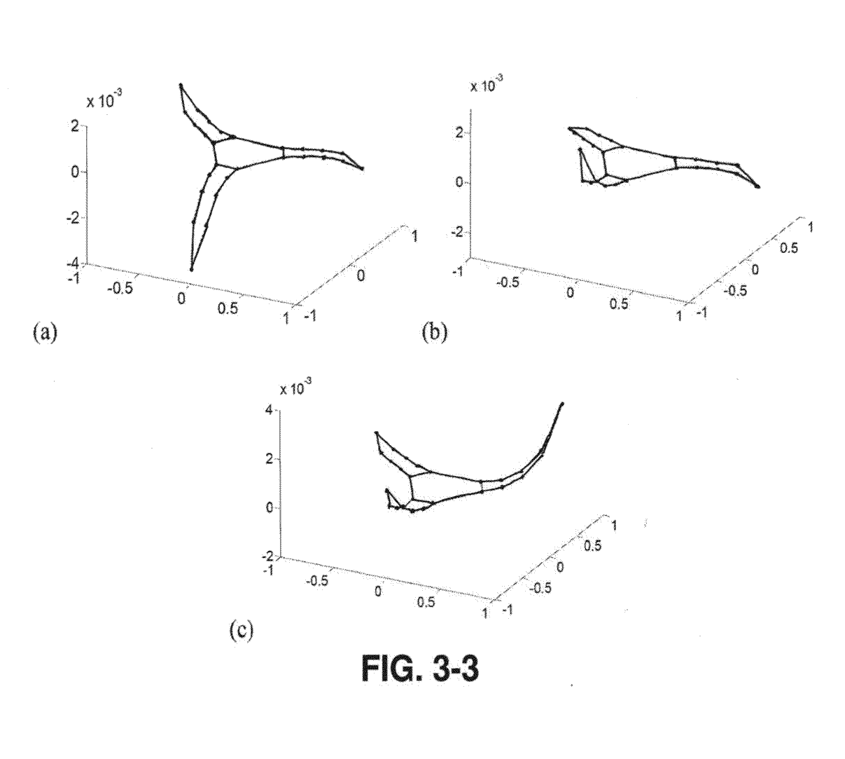

FIG. 3-1 shows a frontal view of a wind turbine according to one embodiment of the present invention.

FIG. 3-2: CMIF plot used to identify natural frequencies of the turbine rotor and hub assembly according to one embodiment of the present invention.

FIG. 3-3: Deflection shapes for modes of vibration near 8.6 Hz showing phase difference between repeated roots. Axes: x, y and deflection amplitude. (a) Asymmetric bending. (b) Asymmetric bending of second root. (c) Symmetric bending of third root.

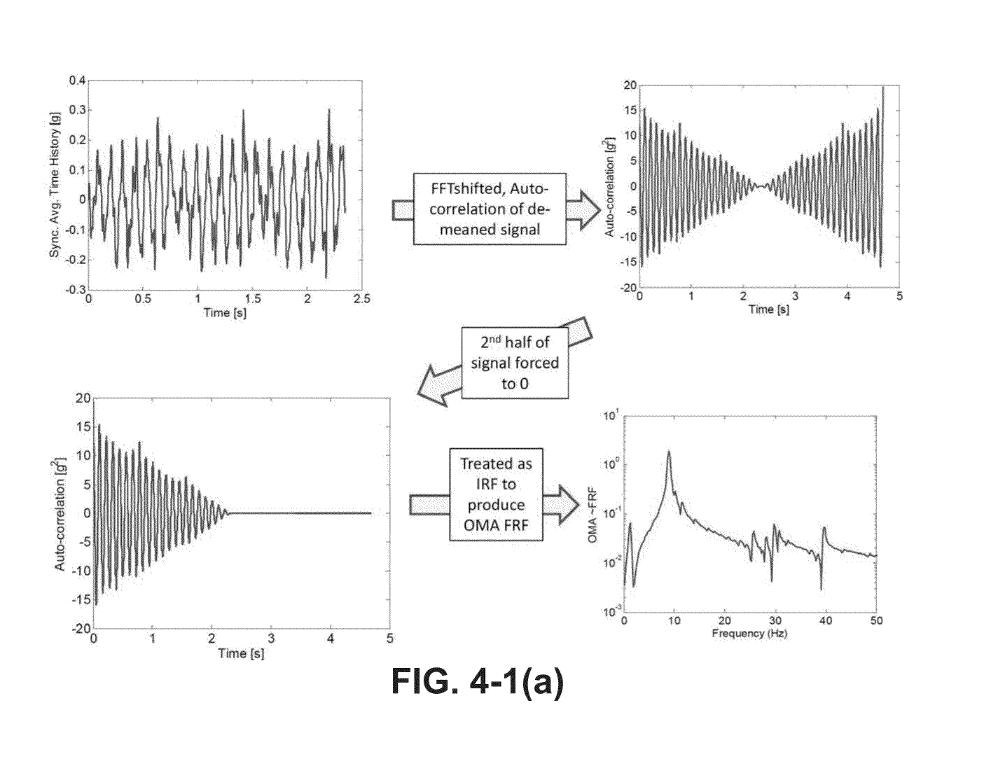

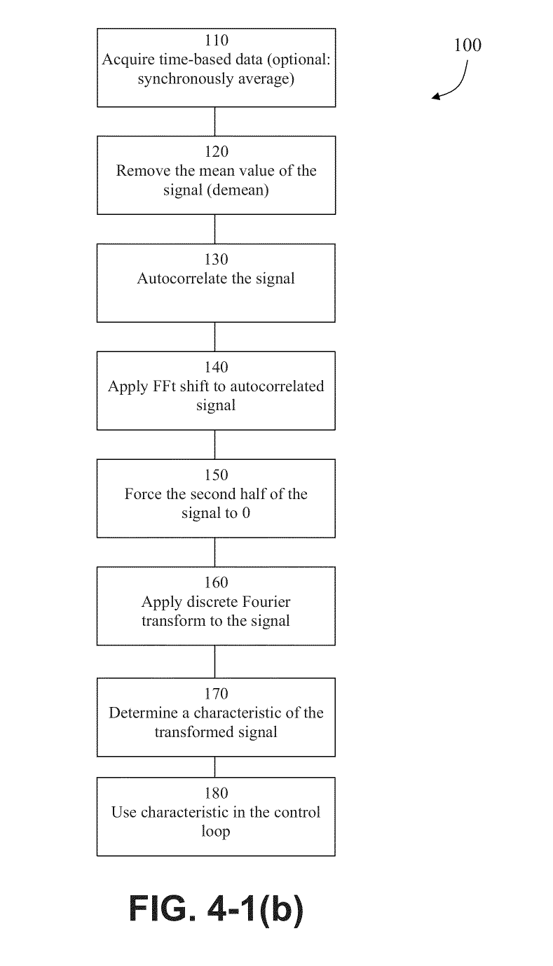

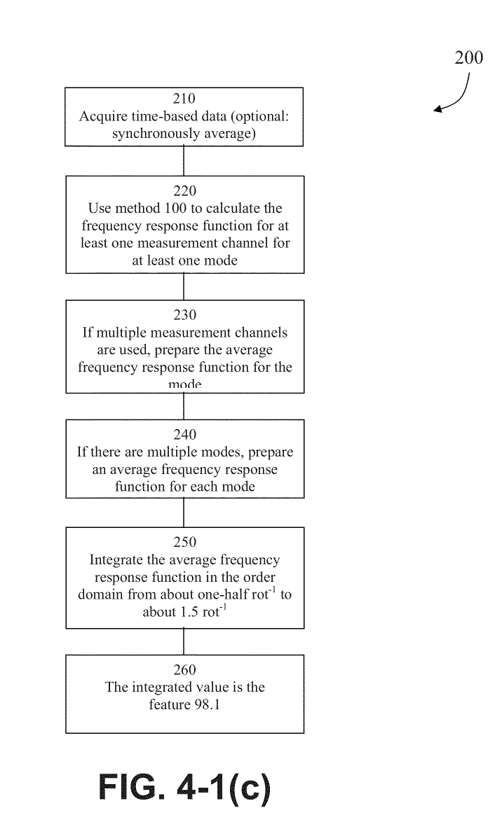

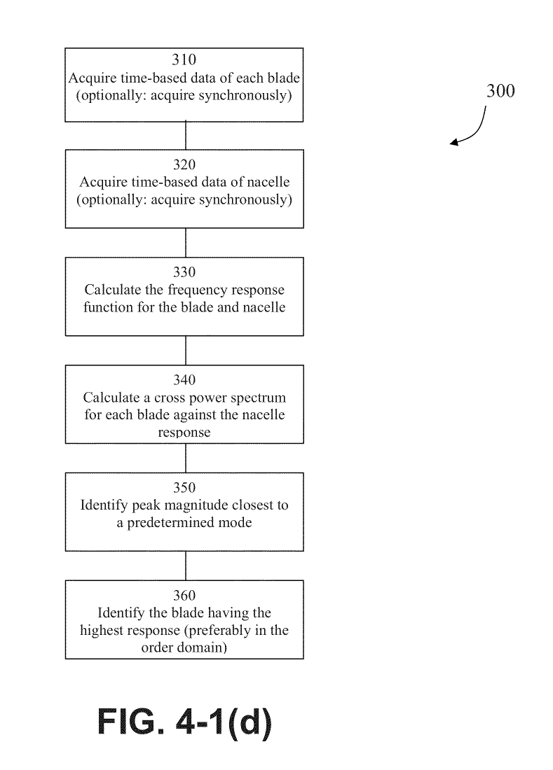

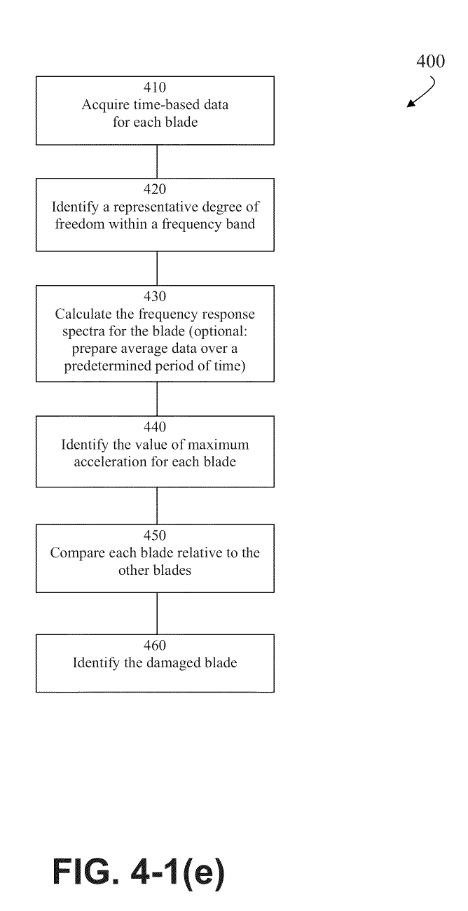

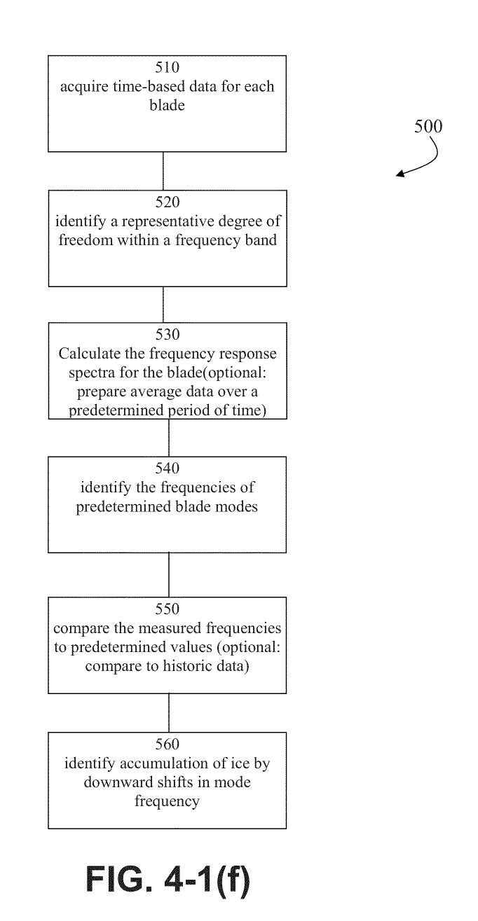

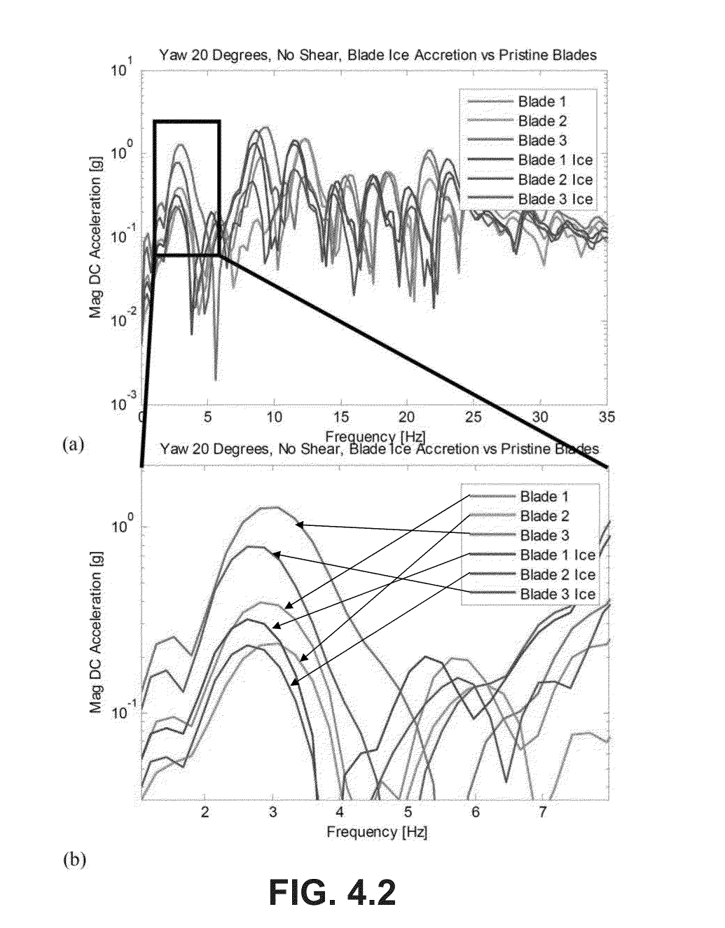

FIG. 4-1(a): OMA data processing flowchart according to one embodiment of the present invention.

FIG. 4-1(b): a block diagram of a operational modal identification method according to another embodiment of the present invention.

FIG. 4-1(c): a block diagram of a yaw control method according to another embodiment of the present invention.

FIG. 4-1(d): a block diagram of a pitch control method according to another embodiment of the present invention.

FIG. 4-1(e): a block diagram of a damage identification method according to another embodiment of the present invention.

FIG. 4-1(f): a block diagram of an ice accumulation detection method according to another embodiment of the present invention.

FIG. 4-2: Example of frequency bounding process according to one embodiment of the present invention: (a) linear spectra of blade ice accretion and pristine blades for Flap DOF at 20° yaw angle; and (b) detailed view at frequency of interest.

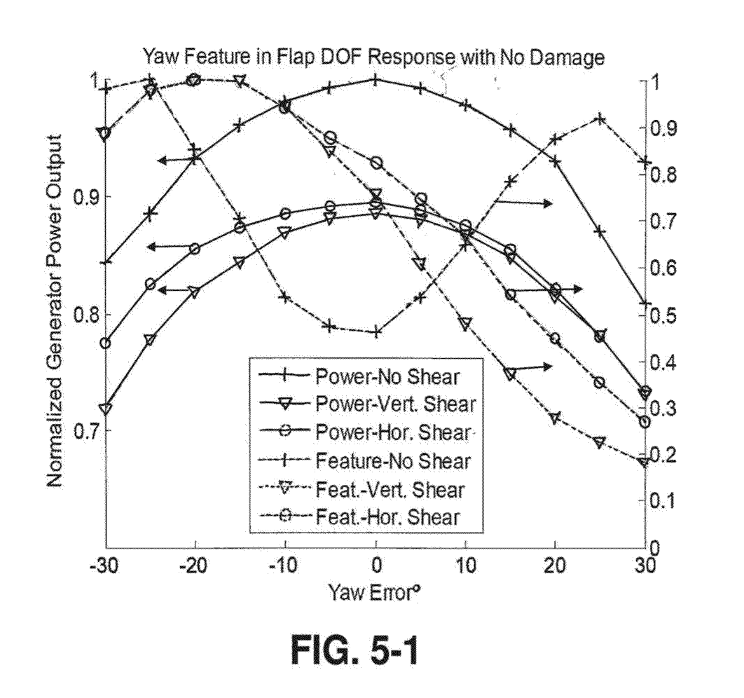

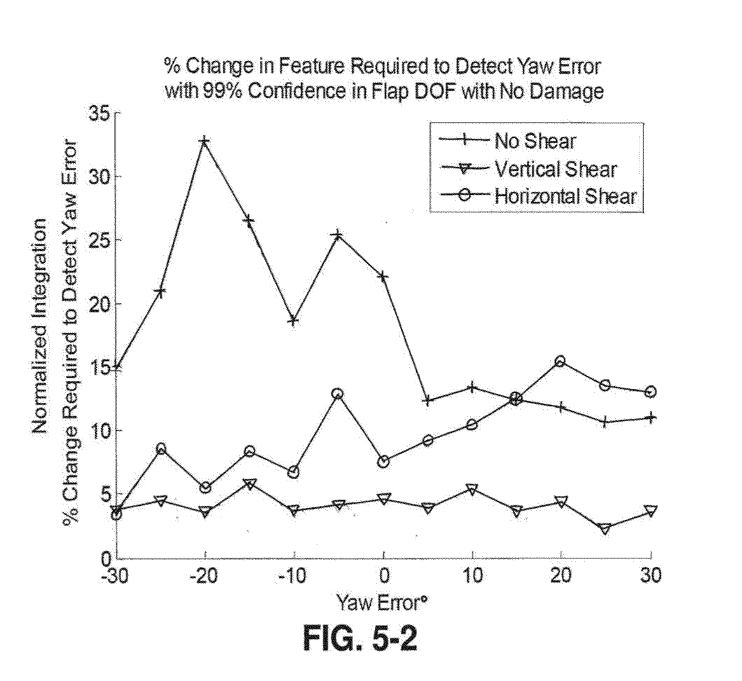

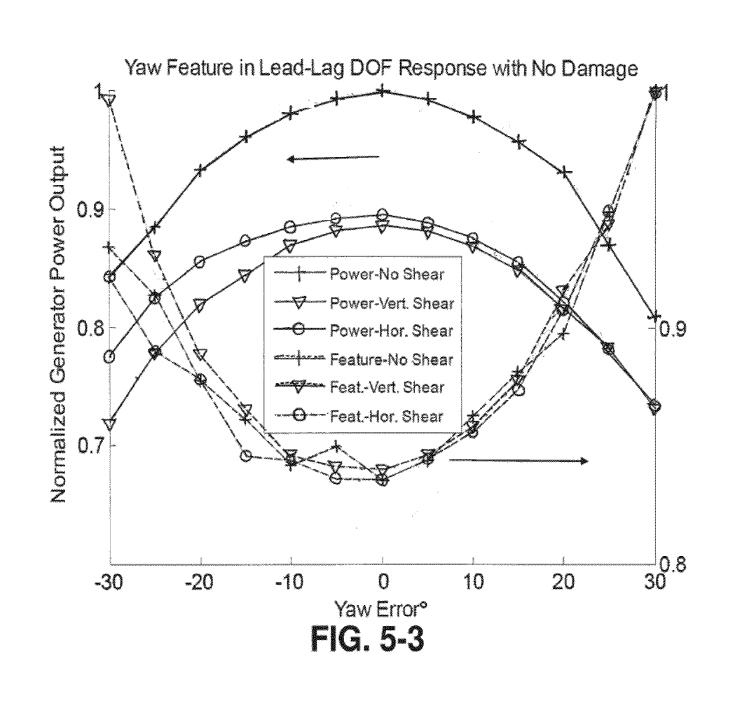

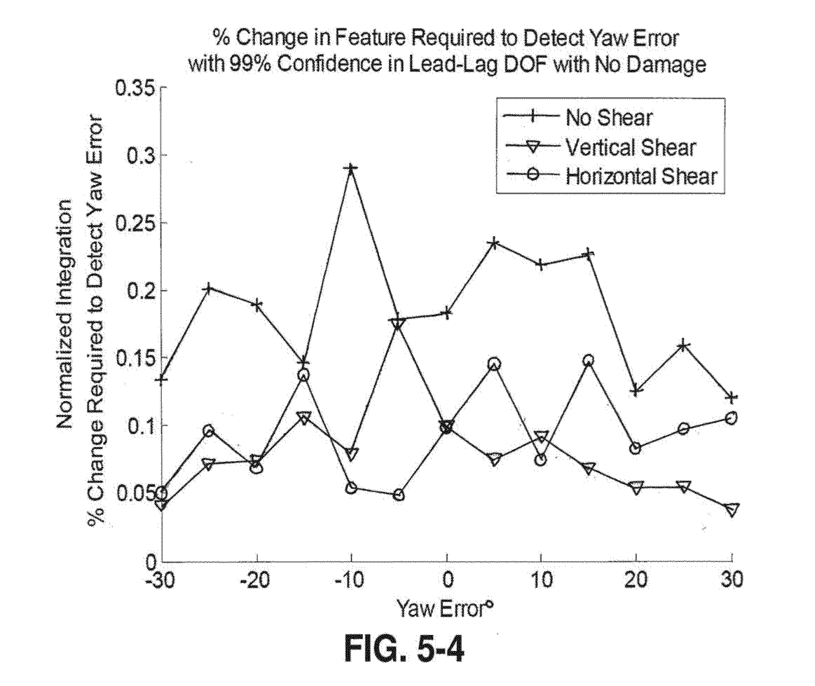

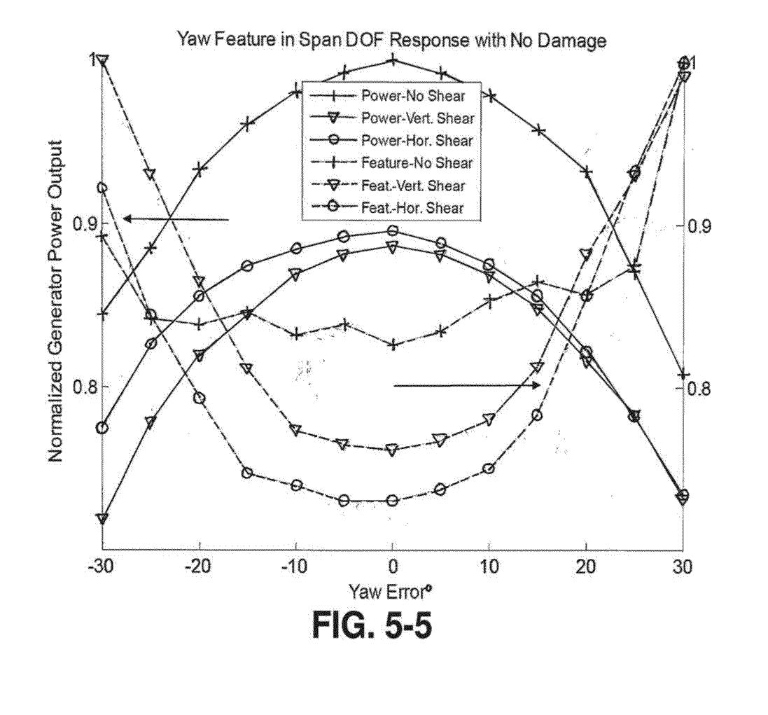

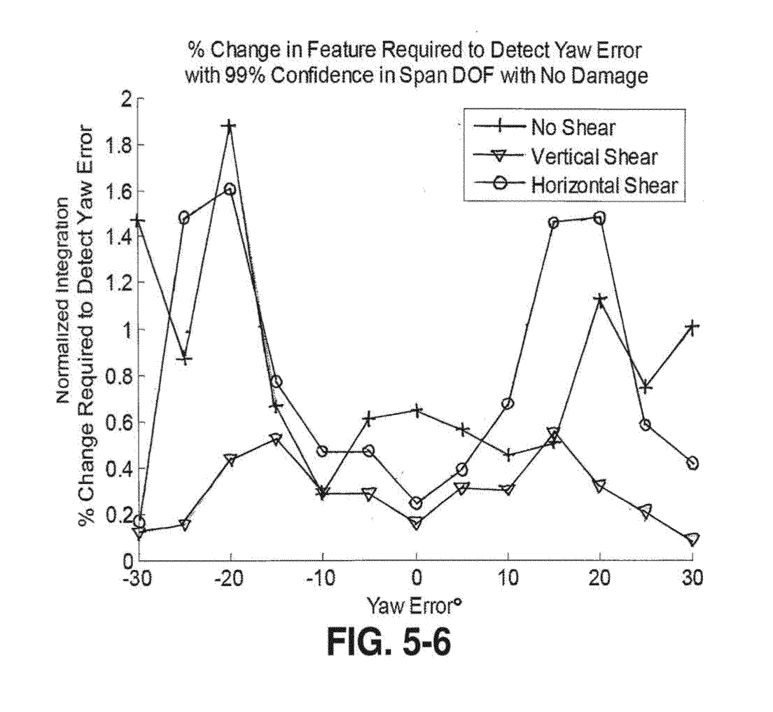

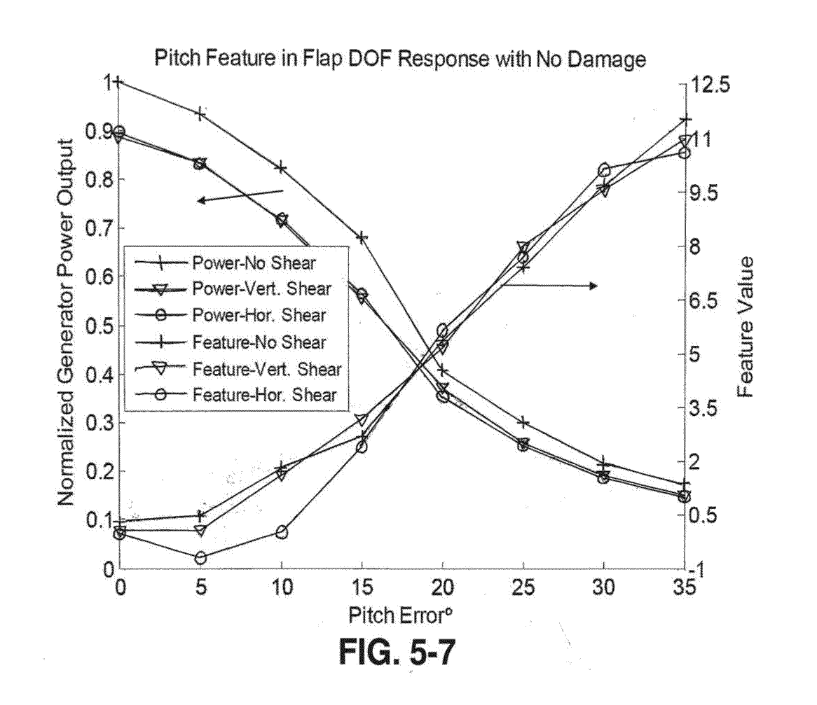

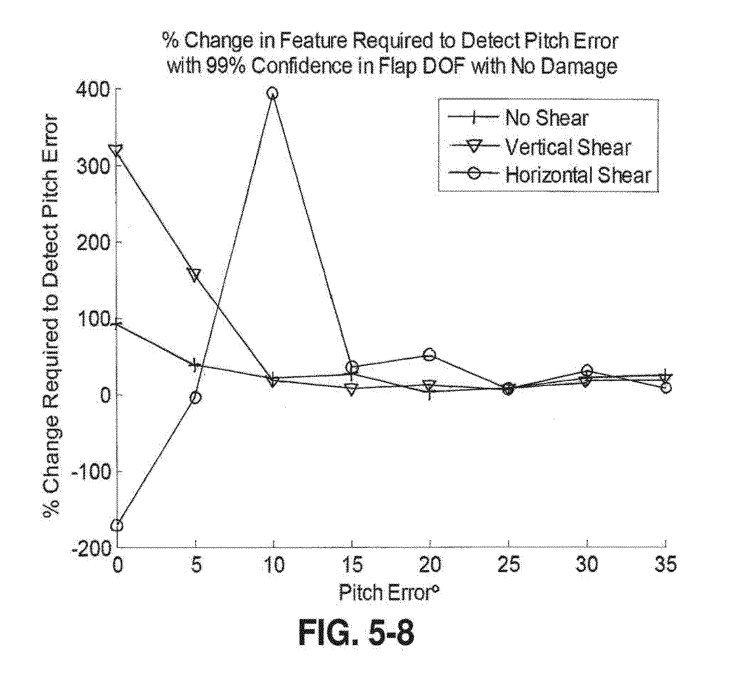

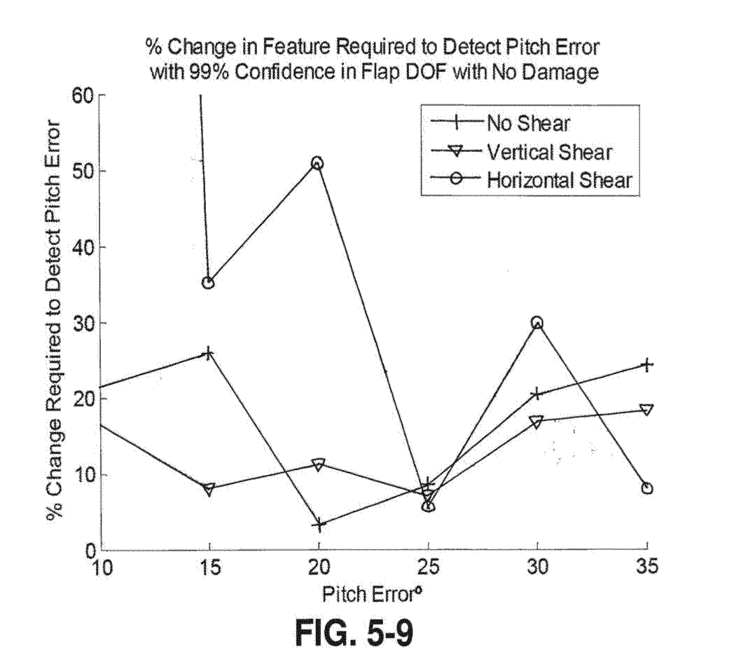

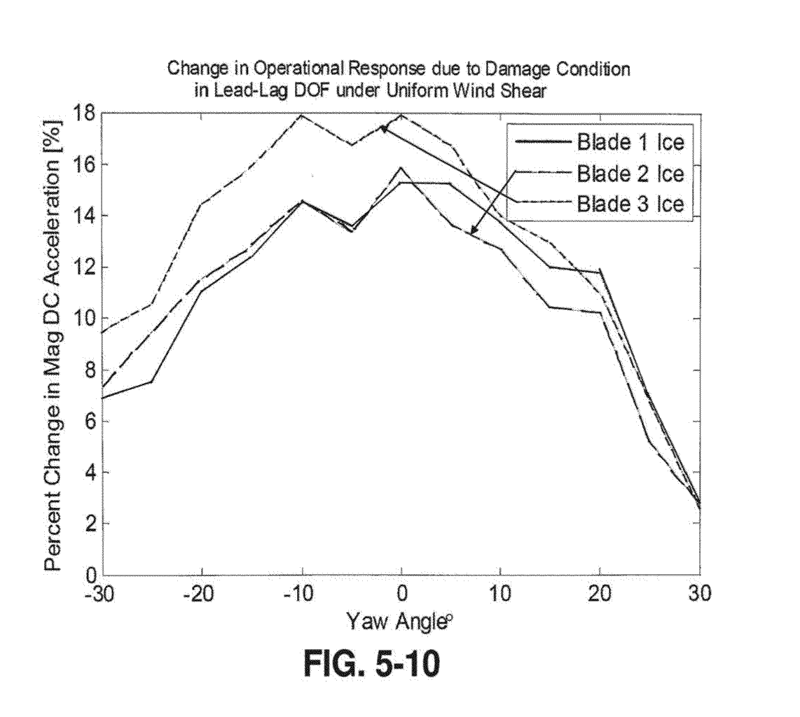

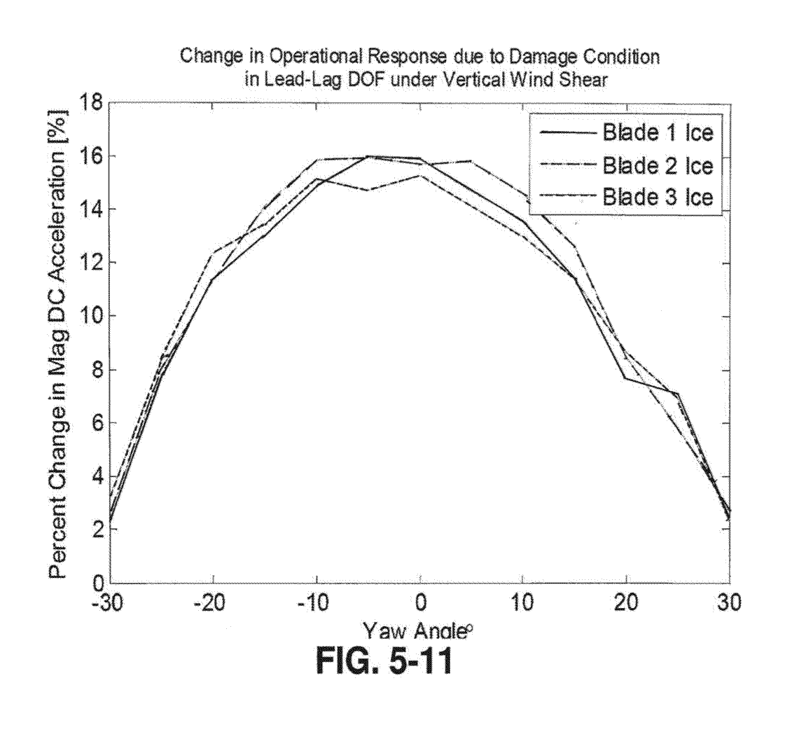

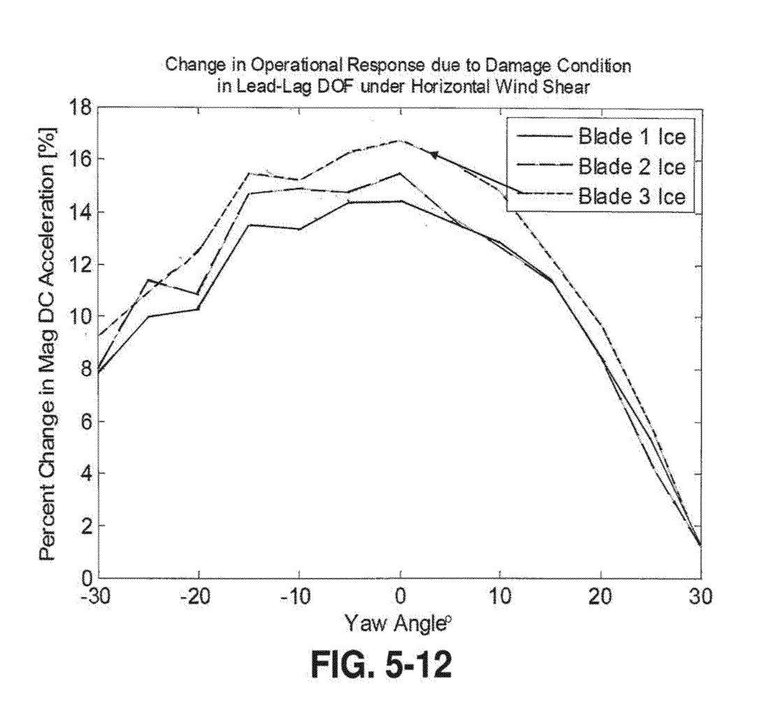

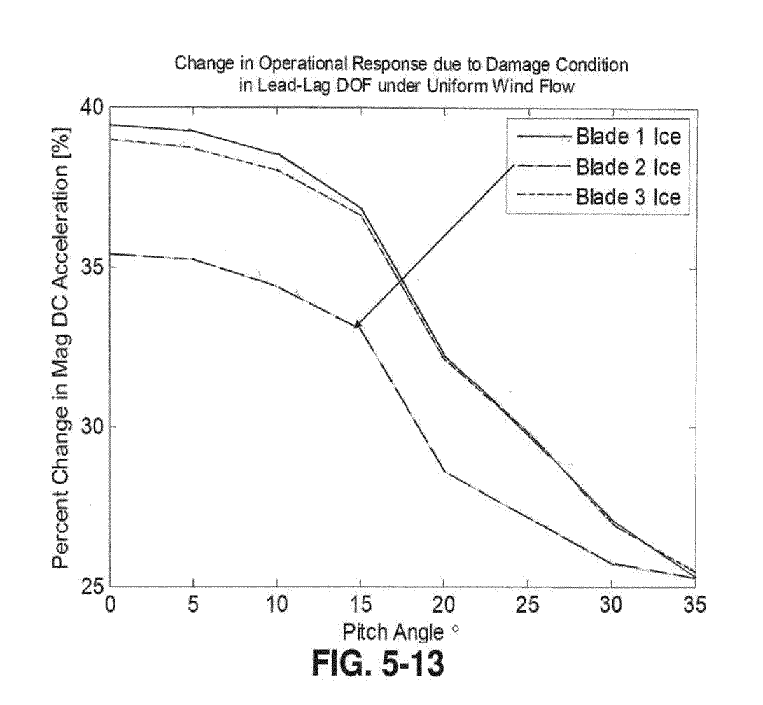

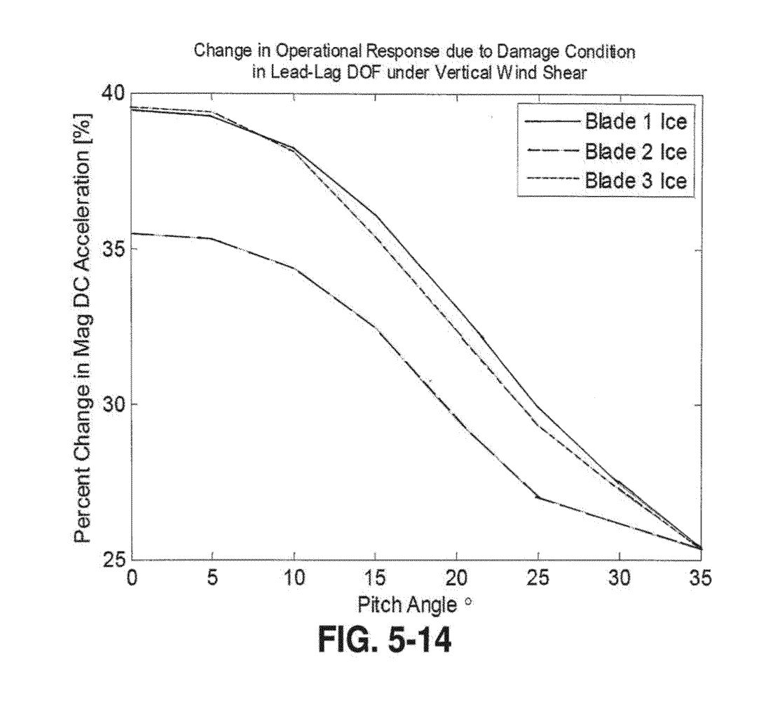

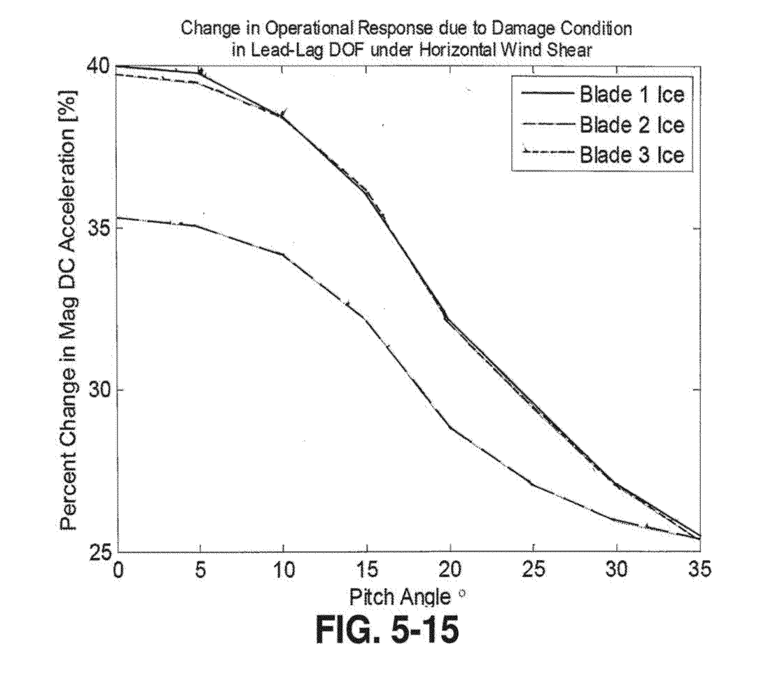

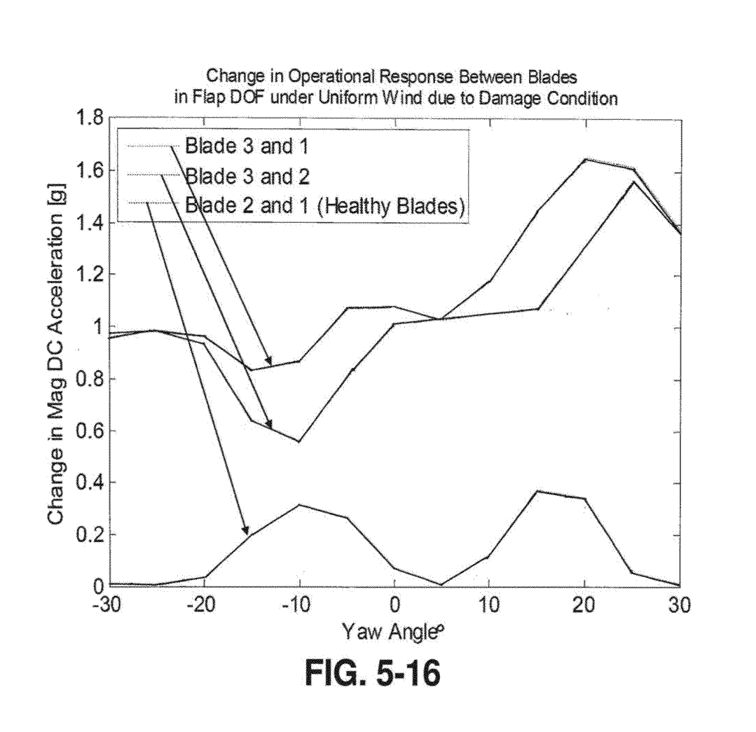

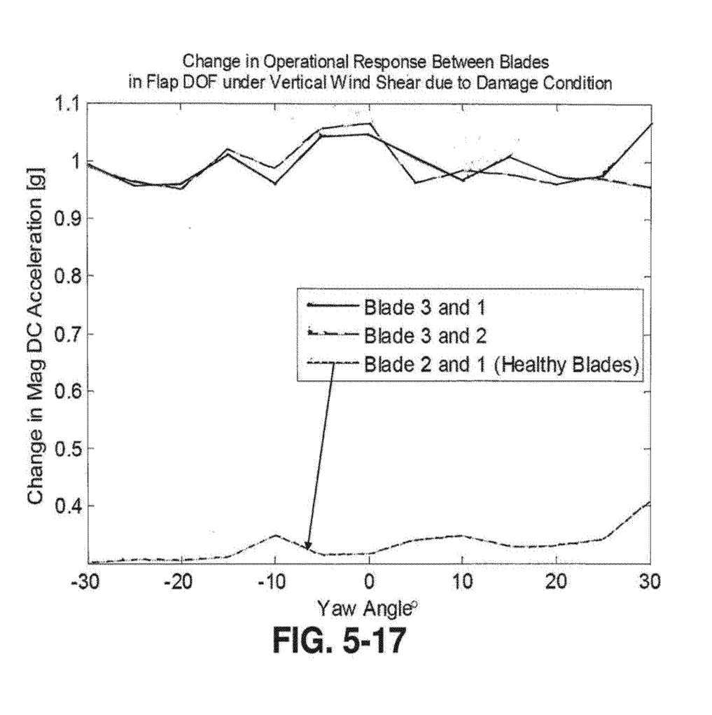

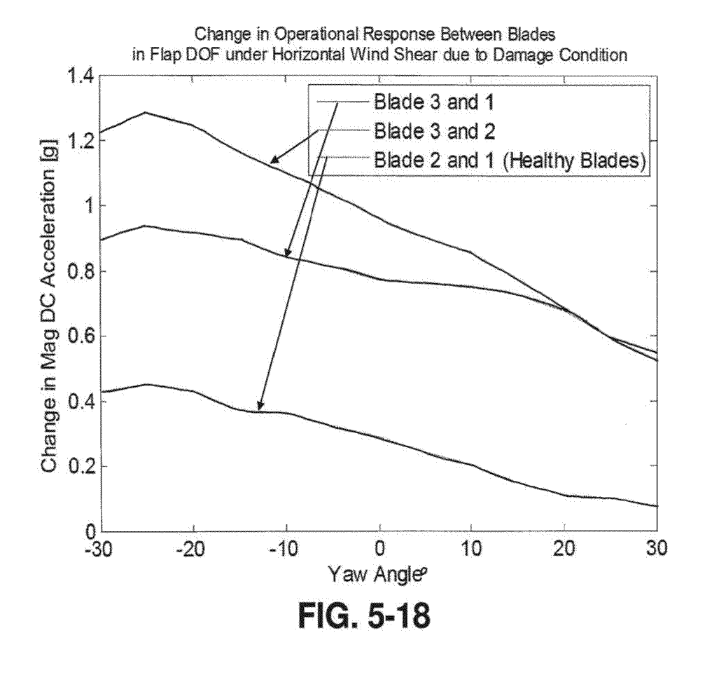

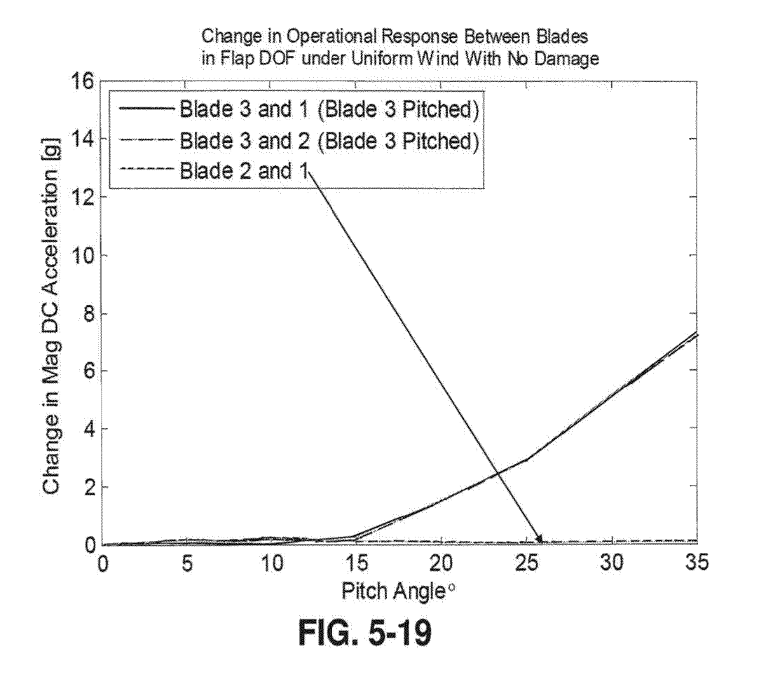

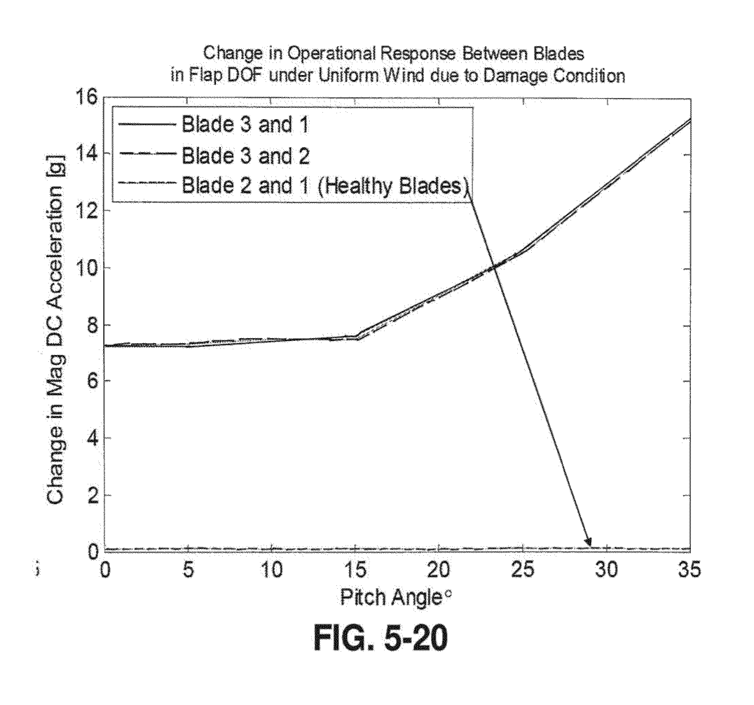

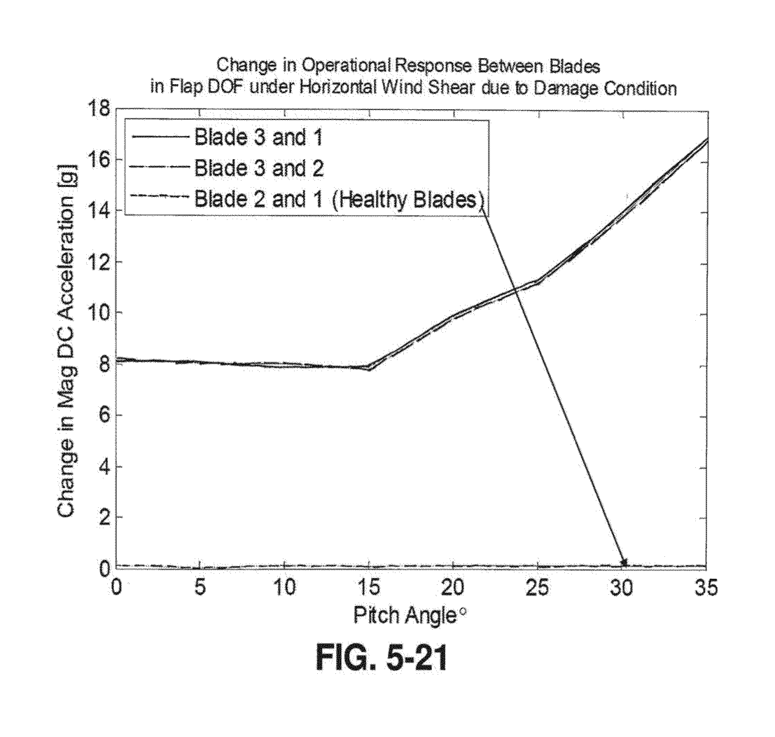

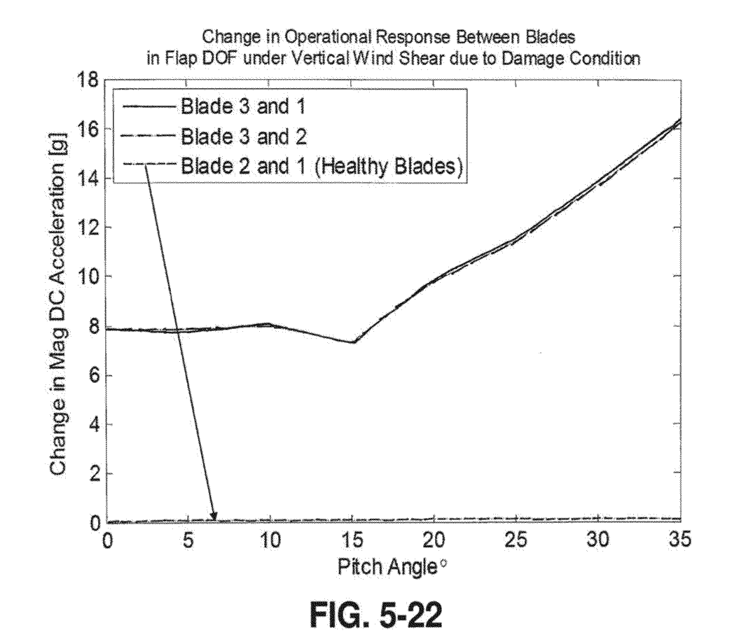

FIG. 5-1: normalized yaw feature and power vs. yaw error angle for flap DOF.

FIG. 5-2: Sensitivity of yaw feature vs. yaw error angle for flap DOF.

FIG. 5-3: Normalized yaw feature and power vs. yaw error angle for lead-lag DOF.

FIG. 5-4: Sensitivity of yaw feature vs. yaw error angle for lead-lag DOF.

FIG. 5-5: Normalized yaw feature and power vs. yaw error angle for span DOF.

FIG. 5-6: Sensitivity of yaw feature vs. yaw error angle for span DOF.

FIG. 5-7: Feature value and power curves for uniform and vertical shear wind conditions.

FIG. 5-8: Pitch error sensitivity.

FIG. 5-9: Pitch error sensitivity (10° to 35°).

FIG. 5-10: Edge-wise percent change in the magnitude of acceleration for each blade vs. yaw angle at 1 rot⁻¹ with ice accretion in uniform wind flow.

FIG. 5-11: Edge-wise percent change in the magnitude of acceleration for each blade vs. yaw angle with ice accretion in vertical shear flow.

FIG. 5-12: Edge-wise percent change in the magnitude of acceleration for each blade vs. yaw angle with ice accretion in horizontal shear flow.

FIG. 5-13: Edge-wise percent change in the magnitude of acceleration for each blade vs. pitch angle at 1 rot⁻¹ with ice accretion in uniform wind flow.

FIG. 5-14: Edge-wise percent change in the magnitude of acceleration for each blade vs. pitch angle with ice accretion in vertical shear flow.

FIG. 5-15: Edge-wise percent change in the magnitude of acceleration for each blade vs. pitch angle with ice accretion in horizontal shear flow.

FIG. 5-16: Comparison of the change in operational response between blades vs. yaw angle at 2 rot⁻¹ for the flap DOF in uniform wind flow when damage is present in a single rotor blade (Blade 3).

FIG. 5-17: Comparison of the change in operational response between blades vs. yaw angle for the flap DOF in vertical shear wind flow when damage is present in a single blade (Blade 3).

FIG. 5-18: Comparison of the change in operational response between blades vs. yaw angle for the flap DOF in horizontal shear flow when damage is present in a single blade (Blade 3).

FIG. 5-19: Comparison of the change in operational response between blades vs. pitch angle at 2 rot⁻¹ for the flap DOF in uniform wind flow without the presence of damage.

FIG. 5-20: Comparison of the change in operational response between blades vs. pitch angle at 2 rot⁻¹ for the flap DOF in horizontal shear flow when damage is present in a single blade (Blade 3).

FIG. 5-21: Comparison of the change in operational response between blades vs. pitch angle for the flap DOF in horizontal shear wind flow when damage is present in a single blade (Blade 3).

FIG. 5-22: Comparison of the change in operational response between blades vs. pitch angle for the flap DOF in vertical shear flow when damage is present in a single blade (Blade 3).

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims.

The use of an N-series prefix for an element number (N______.______) refers to an element that is the same as the non-prefixed element (______.______), except as shown and described thereafter The usage of words indicating preference, such as “preferably,” refers to features and aspects that are present in at least one embodiment, but which are optional for some embodiments. As an example, an element 1110 would be the same as element 110, except for those different features of element 1110 shown and described. Further, common elements and common features of related elements are drawn in the same manner in different figures, and/or use the same symbology in different figures. As such, it is not necessary to describe the features of 1110 and 110 that are the same, since these common features are apparent to a person of ordinary skill in the related field of technology. This description convention also applies to the use of prime (′), double prime (″), and triple prime (′″) suffixed element numbers. Therefore, it is not necessary to describe the features of 20.1, 20.1′, 20.1″, and 20.1′″ that are the same, since these common features are apparent to persons of ordinary skill in the related field of technology. Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

Various embodiments of the present invention pertain to methods and apparatus for improved control of wind turbines. It has been found that the modal response of wind turbine blades can be used to improve the overall operation of the wind turbine, such as with respect to power generation, detection of the health of the wind turbine, reduction in stresses during operation, and detection of accumulations of ice. Although what will be shown and described are methods and apparatus for acquiring data, processing the data, and controlling a wind turbine, it is appreciated that such methods and apparatus are applicable to other systems other than wind turbines.

In one embodiment, the modal response of the blades is detected by acquiring a signal corresponding to motion of the blades. The signal includes a steady, DC component related to the prevailing average wind velocity. However, the signal also includes modal vibrational data, since the prevailing winds are non-steady. These non-steady flows (or steady flows having a nonuniform distribution across the face plane of the wind turbine) can be considered as impact-type loads occurring once per revolution on the rotor system. In some embodiments the blade motion data is analyzed on a per revolution basis, referred to herein as the order domain.

In another embodiment of the present invention, the frequency response function of a blade is determined in real-time based on motion data for that blade. Preferably, this frequency response function is prepared in the order domain, and then the average frequency response function for a mode is integrated in the order domain from about one half per rotation to 1½ per rotation. It has been found that this integrated value is sensitive to errors in the yaw angle of the wind turbine. Therefore, a control system using this integrated value in a feedback loop can achieve higher power levels by reducing the yaw error.

In another embodiment, the modal response to the blade is compared to the modal response of another blade. In some embodiments, these responses are averaged over a number of revolutions, or over a period of time. If the modal response of one blade is sufficiently different from that of another blade, than one of the blades may be flagged as having damage to it. In yet other embodiments the modal response blade is compared to the historical modal response of the same blade. Damage of the blade can be detected as changes in the modal frequency, changes in the magnitude of the modal response, changes to the half-power band of frequencies for that mode, or changes in the measurement of the phase angle related to that mode.

In still other rent embodiments, the modal response of one or more blades can be used to detect potential accumulation of ice on the blade. For example, the presence of ice on a blade will shift the modal frequencies, especially in consideration of the additional mass of the ice. This additional mass can have a tendency to reduce a modal frequency, and that reduction in frequency can be used as an indicator of ice.

In yet another embodiment, the response of a blade is compared to the response of the nacelle or other structure of the wind turbine. A power spectrum for the blade can be cross compared to the power spectrum of the nacelle. The blade having the highest magnitude, especially within a predetermined frequency band, may be a blade whose pitch angle is too great relative to the other blades.

It has been shown that a decrease in the accuracy of a wind turbine's yaw control due to hysteresis and other factors results in loss in energy capture by the rotor. As a cost-effective means of characterizing the turbine's dynamic response when such losses are experienced, it has been demonstrated that sensors (as one example, inertial sensors) can be used either in the rotor or the nacelle to measure static and dynamic variables that are correlated with swept wind loads on the blades. It was shown using inertial sensors in the rotor that a 5 degree error in the yaw set point of the nacelle resulted in a 1% decrease in the power output and a 70% increase in the dynamic loads to the drive train. Based on these measurements, one embodiment of the present invention pertains to a method in which the yaw set point can be tuned to shape the loads on the rotor to maximize energy capture and maximize the reliability of the turbine components. Various embodiments of the present invention pertain to a data measurement and analysis methodology using integrated blade and nacelle inertial sensors for measurement of a wind turbine's yaw angle error.

One embodiment of the present invention pertains to a methodology for developing online dynamic models for wind turbines and wind farms for use in operational decision-making and automatic control. By using models that relate the wind states at upstream wind turbines to the dynamic performance of rotors at downstream wind turbines, the bandwidth of control actions could be increased. FIG. 1 illustrates one concept of system identification method according to one embodiment of the present invention, as applied to a wind farm 20. Farm 20 includes a plurality of individual wind turbines 30, including wind turbines 30.1 located near the front of farm 20 (the front of the wind farm being defined by those wind turbines that are the first to receive wind from a given direction). Further, there are a plurality of wind turbines 30.2 located within farm 20, some of these turbines 30.2 being exposed to wind conditions that are a mixture of free stream air as well as air the turbulence of which has been increased by upstream wind turbines 30.1.

The potential uses extend beyond condition monitoring of wind turbines and performance monitoring of wind farms. For example, assuming a wind speed of 15 m/s, a modern utility scale wind turbine using rate feedback based on low speed shaft speed would have at least about 3 rotor diameters (or 10 sec) lead time to command its pitch and yaw actuators to suppress gusts. In some embodiments, the lag in response of the turbine control laws due to the flexing of a 25 m long blade with its first natural frequency near 0.3 Hz could be reduced by several seconds assuming (in some embodiments) a single degree of freedom flap of the blade. These speed-ups in anticipatory control would result in a reduction in dynamic loads to the drive train resulting in enhanced reliability in the gearbox, bearings, and generator over the twenty-year life of the turbine.

One methodology of online system identification proposed here involves the creation of potentially multiple-input multiple-output frequency response functions relating wind speed (and possibly direction) variables that are measured at upstream wind turbines or anemometer towers to blade responses or drive train responses of downstream turbines. One embodiment of this method has been illustrated in the context of a Micon 65/13 fixed speed, pitch, and yaw turbine with CX-100 rotor blades shown in FIG. 2(a). This turbine was assembled with a smart sensored blade and tested by Sandia National Laboratory and Purdue University at the U.S. Department of Agriculture Conservation and Production Research Laboratory in Bushland, Tex. In addition to the in-blade acceleration measurements, drive train rotational position, velocity and power sensors, and wind in-flow field arrayed sensors were available for processing.

FIG. 3(a) shows the wind speed measurement taken 1.5 rotor diameters upstream from the turbine at hub height in the along-wind (rotor axis) direction. The data indicates that over a 3 hr period the mean speed decreases steadily. The autopower spectra shown in FIG. 3(b) were estimated using 50% overlap spectral averaging, which was applied to the 180 min dataset and also to 18 min sequential datasets to quantify the change in spectral content with time. The spectral magnitudes above 0.2 Hz indicate that the dynamic components followed a random process that could be modeled using an exponential function (i.e., in some embodiments, a straight line in log-log space), which rolls off 60 dB by 10 Hz. Note that this variation in wind speed and wind fluctuations result in increased loads to the drive train. The evolution of the wind spectra in FIG. 3(b) suggests that the dynamic loads are decreasing with time.

FIG. 4(a) shows a set of autopower spectra for the flap direction accelerometer at the 8m span position along the blade. These spectra were calculated at different points in time during the 3 hr data acquisition period using 22 min block sizes of data, which were processed in the same manner as previously described. Note that there are variations in the autopower amplitudes for each of the sequential 22 min datasets.

To capture the effects of these variations on the turbine response for use in implementing control algorithms, frequency response function amplitudes were estimated by normalizing the response spectra with wind speed spectra (FIG. 3(b)) through an H₁ formulation to minimize noise in the blade flap acceleration measurements. Any type of input-output model could be developed including autoregressive, neural network, nonlinear frequency domain, reverse-path, etc. models. Because wind and turbine data were not synchronously acquired, phase and coherence functions could not be estimated.

FIG. 4(b) is a plot of this frequency response function magnitude, and it suggests that the frequency response functions vary less than the autopowers over some of the frequency range (such as at the rotor speed harmonics). For example, the variation in the frequency response amplitude at 0.92 Hz in FIG. 4(b) is an order of magnitude less than the variation in the autopower in FIG. 4(a) at that frequency. Because the frequency response functions are nearly constant over the range of wind speed variations, FIG. 4(b) suggests that this relationship can serve as a predictive model for use in control and condition monitoring of the wind turbine.

One embodiment of the present invention pertains to apparatus and methods for controlling the yaw angle of a wind turbine that is located downstream of a fluctuating disturbance, such as a second wind turbine. It is understood that the term “upstream” refers to a location receiving energy from the wind before those same atmospheric conditions reach a second (“downstream”) wind turbine. As one example, the two wind turbines could be substantially side by side, yet both be within atmospheric conditions in which the direction of the wind (either steady state, or gusting) is changing. One example would include wind turbines pointed in substantially the same direction for wind energy capture, but in which the direction of the wind changes such that one wind turbine receives a side gust before the adjacent wind turbine receives that same side gust.

Yet another example of a fluctuating disturbance could be a stationary object (such as a building) located in fixed relationship to the downstream wind turbine. In such cases, the fluctuation occurs when the direction of wind changes, such that the fixed object becomes upstream (or upwind) of the wind turbine because of the change in direction of the wind. In some of these embodiments, the downstream wind turbine includes a sensor providing a signal as to the angular orientation of the downstream wind turbine relative to the earth, and further preprogrammed software that recognizes the location of the fixed object relative to the wind turbine and locations on the Earth. Further, yet other embodiments of the present invention contemplate a downstream wind turbine capable of recognizing its angular orientation relative to a field of adjacent wind turbines.

In one embodiment the method includes one or more sensors on at least one blade of the upstream turbine. In yet other embodiments, there are one or more sensors providing information such as the angular orientation of the upstream wind turbine, the rotational speed of the upstream wind turbine, or other information pertaining to the current state of the upstream wind turbine. These sensors are in electrical communication with an electronic controller. The sensors measure the dynamic response of an upstream blade during operation, or other information pertaining to operation of the upstream wind turbine. Examples of the sensors include accelerometers, strain gages, position sensors, velocity sensors, or other sensors capable of providing signals corresponding to acceleration, strain, velocity, position, or the like. Yet other embodiments of the present invention include the use of low frequency accelerometers providing signals that can be used to sense a local initial reference frame from the rotating mass, such as those described in U.S. patent application Ser. No. 12/992,804, incorporated herein by reference.

The electronic controller receives the signal from the sensors and controls a variable of the downstream wind turbine to be controlled. In some embodiments, the controlled variable can be the yaw angle of the downstream turbine, the vibration of any one of the blades of the downstream turbine, the pitch angle of the blades of the downstream turbine, or other actuatable aspects of the downstream turbine.

From any of the control variables discussed above, an error signal can be determined by software within the controller. This error signal is then appropriately filtered, and the filtered results can be used to drive an actuator that repositions the wind turbine in terms of its yaw angle, as one example. As another example, a downstream turbine can begin to change its yaw angle based on movement of an upstream wind turbine, or a change in the relationship between the downstream wind turbine and a fixed object (such that the fixed object begins to aerodynamically “shadow” the downstream wind turbine). As yet another example, a change in speed in an upstream wind turbine, indicating an increase in wind speed, can be used to increase the pitch angle of the blades of a downstream wind turbine in anticipation of higher wind speeds reaching the downstream wind turbine.

Various other embodiments of the present invention include the achievement of greater power output using integrated blade and nacelle inertial sensors to characterize the response associated with swept wind loading on the rotor blades. This information can be used in real-time to observe an increase in dynamic excitation, which can be used to tune the yaw angle and reshape the rotor loads. By applying this methodology, it is shown that the wind turbine power output increases by 12% and the asymmetric rotor fatigue loads decrease. With better loading observations, enhanced maintenance scheduling can also be implemented for individual turbines, thereby decreasing down time and maximizing the life of wind turbine components.

An experimental apparatus according to one embodiment was designed to control the wind state and wind turbine degrees of freedom (rotor pitch, yaw, and longitudinal position) and to measure the rotor response. As shown in FIG. 6, the apparatus was built around a Whisper 100™ 2 m diameter rotor wind turbine, manufactured by Southwest Windpower®. The wind was generated using four 30,000 ft³/min axial fans. To develop a more laminar flow state, the airflow generated by the fans was forced through a stabilizing honeycomb core that included 0.25 inch polycarbonate cells.

Each of the turbine blades was instrumented with a triaxial, DC-coupled accelerometer and a uniaxial AC-coupled accelerometer. The triaxial and uniaxial accelerometers were attached on the low-pressure side of the blade at a location approximately 14 in and 15 in, respectively, from each of the blade tips (see FIG. 7). Operational data was acquired from these accelerometers using a battery-powered data acquisition system, which was mounted on the rotating hub. Data was streamed wirelessly from the rotating hub via a wireless USB 2.0 transmitter. Turbine voltage output and speed were measured through a separate, wired data acquisition system. FIG. 8 shows a close-up view of the nacelle of the wind turbine that was fitted with a fixture to hold the data acquisition and wireless transmission hardware. The fixture was designed to position this instrumentation symmetrically around the hub to avoid excessive imbalance forces during operation

The free dynamic response was first investigated by means of a multi-reference modal impact test. FIG. 7 illustrates the input force (white dots) and output response (yellow symbols) degrees of freedom (DOFs) for this test. Because of the symmetric features of the turbine's rotor, the free response included repeated and closely spaced modes of vibration. To help separate and identify these modes, a Complex Mode Indicator Function (CMIF) was used to analyze the multiple-input, multiple-output Frequency Response Function (FRF) data. The CMIF was constructed by performing the singular value decomposition of the FRF matrix in Matlab® as follows:

[H(jω)]_{27×12}^{H}[H((jω)]_{27×12}=[V(jω)]_{12×12}[CMIF(jω)]_{12×12}[V(jω)]_{12×12}^{H} (1)

The CMIF was plotted in FIG. 9 and a summary of the findings from the CMIF are given in Table 1. The mode shape generalizations of the free response were tabulated for use in correlating the operational rotordynamic response to the distribution of wind loads on the rotor.

Upon establishing an understanding of the basic free response dynamics of the rotor, the axial fans were then utilized to investigate the forced dynamic response and its correlation with the yaw angle. The fans were set at a steady-state speed and the accelerometer response measurements were collected wirelessly while the rotor freely rotated. The yaw position of the turbine was then changed from 0° to 5°, 10°, 20°, and 30° angles by locking the tail of the turbine in a prescribed location with straps.

Response data was first synchronously averaged, as a means of reducing background noise while preserving the rotordynamics of the turbine in the signal. This technique adequately reduced leakage, eliminating the need for the more intricate signal processing windowing techniques. However, it is understood that yet other embodiments of the present invention include the use of windowing techniques or other methods of reducing background noise. Averaging was accomplished by using the signal from the optical tachometer to establish the block size of each revolution. Note that modes in the low frequency range examined in Table 1 include flap-wise motion due to the increased compliance as compared to the edgewise direction and the input force direction normal to the blade chord. Thus, the flap-wise acceleration channels were the DOFs of interest when analyzing the operational data.

To summarize and condense the flap response of the whole rotor at each yaw angle, the magnitudes of the 3 DC-coupled response spectra were summed to produce one datum pertaining to each yaw position. As can be seen from the result shown in FIG. 10, changes in the rotor response were observed as the yaw position deviated from 0°, the direct upwind direction. It was demonstrated that with 5° deviation from a centered yaw position, there are slight decreases in the peaks near the rotordynamic modes at 15 and 29 Hz. Another change in the spectra existed at the 9 Hz mode, where the response increased by almost 70%. Both of these trends were magnified as the yaw angle deviated further from 0°. This mode of rotor-dynamic response is due to the nature of the forcing function (wind input)—a function of both the frequency spectra and spatial velocity (force) distribution. Even though turbines of larger size will posses different dynamics, it is hypothesized that their dynamic response will also exhibit similar observable trends.

Finally, the turbine's performance was investigated in relationship to the yaw angle. The unrectified output voltage was acquired with the previously mentioned data sets and was plotted in FIG. 11. For a more quantifiable perspective, the mean and percent difference were tabulated in Table 2.

There are implications of these embodiments on the turbine's performance both from an energy capture and reliability perspective. The data in FIG. 8 demonstrated that with a 5% change in the yaw angle, there was a 70% increase in the dynamic response of the rotor blades. This increase in asymmetric loading to the rotor causes the drive train to be loaded in a manner that would reduce its reliability long term and/or increase the requirements for maintenance. The turbine's energy capture was also investigated in relationship to the yaw angle. The unrectified output voltage was acquired simultaneously with the previously mentioned data sets and was plotted in FIG.9. It initially appeared that a 5° offset caused little decrease in the power output; however, the mean and percent difference were compiled in Table 2.

A 1.23% loss was measured for a 5° yaw misalignment. The cost influence of such a loss on a 3 MW turbine's revenue production can be estimated. Assuming electricity sales of $100/MWh (10¢/kWh) and continuous 3MW production, a 1.23% loss will decrease the revenue of the energy company by more than $32,000 per turbine per year. In an array of 30 turbines, this loss becomes nearly 1 million dollars. Assuming a more realistic 1.5MW continuous output, it still amounts to a half million dollar loss. In addition, there will be reductions in reliability of the drive train due to the more severe asymmetric loads introduced by this small yaw point error.

One embodiment of the present invention pertains to apparatus and methods for controlling the yaw angle of a wind turbine. In one embodiment the method includes one or more sensors on at least one blade of the turbine. These sensors are in electrical communication with an electronic controller. The sensors measure the dynamic response of the blade during operation. Examples of the sensors include accelerometers, strain gauges, or other sensors capable of providing signals corresponding to acceleration or strain.

The electronic controller receives the signal from the sensors and determines a variable of the wind turbine. In some embodiments, the controlled variable is the vibrational acceleration of the blade, either in broadband terms, or in predetermined frequency ranges. In some embodiments, the frequency ranges are adapted and configured to each include one of more known modal frequencies of the blade. In yet other embodiments, the controlled variable may be the strain measured on the blade, as analyzed in broadband terms or predetermined frequency ranges similar to that as discussed above.

The electronic controller uses the information provided by the sensor to change the yaw angle of the wind turbine in response to the measurement of the controlled variable. In some embodiments, the measurements from the sensors are compared to a preexisting model of the dynamic response of the blade. In yet other embodiments, the currently measured response is compared to a predetermined model that is periodically updated to account for the age or other characteristics of the wind turbine. In yet other embodiments, the controlled variable is compared to other measurements of the blade made at the same moment in time. As one example, the magnitude and/or phase responses in a particular range of frequencies can be compared to the phase and/or magnitude response in other predetermined ranges or frequencies. One example of this would be comparison of response of the blade at the Nth mode to the responses as measured at the N−1 and N+1 modes.

From any of the comparisons discussed above, an error signal can be determined by software within the controller. This error signal is then appropriately filtered, and the filtered results can be used to drive an actuator that repositions the wind turbine in terms of its yaw angle, as one example.

TABLE 1
Modal properties and mode shape generalizations
of the turbine found using modal impact testing

| ωd (Hz) | Description | |
|---|---|---|
| 2.7 | 1^{st} bending - Two blades in phase and the third | A |
| (2 roots) | blade out of phase w/hub rocking | |
| 5.5 | Asymmetric bending w/one blade in 1^{st} bending + | A |
| | torsion and other blades bending w/hub rocking | |
| 7 | Pseudo-repeated root of 5.5 Hz modal deflection | A |
| | shape w/different phase | |
| 9.4 | 1^{st} bending - Two roots w/asymmetric and one root | M |
| (3 roots) | w/symmetric blade motion, no rocking of hub | |
| 15.2 | 1^{st} bending - Two blades bend in phase and the | A |
| (2 roots) | third blade bends out of phase; no rocking of hub | |
| 19.1 | 2^{nd} bending - One root w/asymmetric and one root | M |
| (2 roots) | w/symmetric blade motion, 2^{nd} bending of blades | |
| 25.8, 27.7, | 2^{nd} bending - Two blades bend in phase and the | A |
| 28.9 | third blade is out of phase, 2^{nd} bending of blades | |
| 30.8 | 2^{nd} bending - Three blades w/symmetric motion in | S |
| | phase undergoing 2^{nd} bending | |
| 39.1 | 2^{nd} bending - two blades w/asymmetric motion in | A |
| | phase in 2^{nd} bending third blade torsion | |
| 41 | 2^{nd} bending - Two blades w/asymmetric motion in | A |
| | phase 2^{nd} bending, third blade torsion | |

Mode Shape Generalization

| | |
|---|---|
| Asymmetric | A |
| Symmetric | S |
| Mixed | M |

TABLE 2
Turbine output voltage and its dependence on yaw angle.

| Angle | Mean | % |
|---|---|---|
| (°) | Voltage (V) | Diff |
| 0 | 3.068 | — |
| 5 | 3.0303 | −1.23 |
| 10 | 2.9309 | −4.47 |
| 15 | 2.5135 | −18.07 |
| 20 | 1.8738 | −38.92 |

To characterize how the rotor forced response of the turbine changed due to yaw and pitch set-point errors and how these changes affected the sensitivity of blade measurements to damage mechanisms, wind speed measurements were taken on a wind turbine 30 as shown in FIG. 2-1. Wind turbine 30 includes a plurality of blades 32 coupled to a hub 34 by one or more pitch actuators 33. In some embodiments, the pitch angle of each blade can be adjusted individually, whereas in other embodiments the actuator includes a collective mechanism to change the pitch angle of all blades simultaneously.

Hub 34 and blades 32 are coupled to a nacelle 36 that includes the gear reduction mechanism and electrical generating machinery of turbine 30. Hub 34 and nacelle 36 are coupled to a support beam 31 by a yaw actuator 37. Actuator 37 receives commands from an electronic controller, as does pitch actuator 33, to control the operation of wind turbine 30.

In various embodiments, wind turbine 30 includes various types of sensors. In some embodiments, at least one blade 32 includes a sensor 50 for detection of blade motion. As shown in FIG. 2-1, in one embodiment sensor 50 is a triaxial accelerometer mounted to each of the blades 32. However, it is understood that in yet other embodiments there can be fewer than three axes of measurement, and in still further embodiments the sensor can be responsive to stress, strain, displacement, or velocity of the blade 32. Preferably, the sensors have sufficient bandwidth to be responsive to vibration of the blade. In some embodiments the preferred bandwidth extends to zero rpm, and up to several hundred hertz, and in yet other embodiments to several thousand hertz. However, it is understood that in still other embodiments a sensor with an upper limit on its bandwidth of about ten hertz is acceptable.

In still other embodiments, there are other sensors that provide their signal to an electronic controller 80. In some embodiments, wind turbine 30 includes an anemometer 55 providing a signal corresponding to wind velocity and a tachometer 54 providing a signal corresponding to rotor speed. In still further embodiments, the nonrotating structure of the wind turbine (including the nacelle, portions of the hub, and the support beam 31) have mounted on them a motion sensor 50 which provides its signal to an electronic controller.

A model of wind turbine 30 was placed at the inlet of the test-bed enclosure to quantify the wind profile for horizontal and vertical wind shear as well as a uniform wind condition. A 10 by 10 matrix of wind speeds totaling 100 discrete wind speed data points were sampled using the cup anemometer placed 6 inches from the honeycomb. The data was linearly interpolated between the sampled points and a color bar was added to better highlight the variation in wind speed. The resulting profile for a non-shear wind condition is plotted in FIG. 2-8. The transparent disk when overlaid on the velocity contour map represents the area of the rotor disk during operation and the arrow indicates the direction of rotation.

To create a vertical and horizontal wind shear condition, screening material was used to shape the wind inflow at the inlet of the test chamber. For the horizontal (side) shear condition, the screening material was used to restrict airflow on the right side enclosure inlet and create a horizontal gradient in wind speed. For the vertical wind shear condition, the screening material was used to restrict airflow on the lower half of the enclosure inlet and create a vertical gradient in wind speed. The resulting wind speed contours for the negative side shear condition and vertical shear condition are plotted in FIG. 2-9.

Wind turbine rotor blade modes of vibration are excited by wind loads to a greater or lesser degree depending on both the frequency of wind loading and the spatial distribution of that loading. Various embodiments of the present invention identify changes in the operating state of the wind turbine rotor by including a characterization of the free dynamic response of the three-bladed rotor system. Knowledge of the free response of the rotor is useful when attempting to monitor the health of the blades because the operational response is a convolution of the blade free response characteristics and the blade forcing function. The mode shapes and resonant frequencies of the rotor can be the modes of vibration that will be most sensitive to changes in the turbine's operating state (i.e. changes in wind state and/or changes in yaw and pitch set point) and blade damage condition.

To identify the free response characteristics of the wind turbine rotor system, a modal impact test was performed. A multi-reference modal impact test was conducted using three measurement degrees of freedom (DOF) that were local to each rotor blade's coordinate system. The measurement degrees of freedom are denoted as follows: X: span, Y: lead-lag and Z: flap (flap is measured perpendicular to the blade surface). FIG. 3-1 illustrates the local degrees of freedom of a rotor blade. In total, there were nine reference channels of data, which were acquired using an Agilent E8401A VXI mainframe that was paired with an E1432A module, which sampled at 51.2 kHz. These nine channels included three DC tri-axial accelerometers. A PCB Piezotronics modally tuned hammer (model 086C01, nominal sensitivity 50 mV/Ibf) was used to apply and measure the impulsive forces in the direction perpendicular to the blade at each point that is indicated on FIG. 3-1 (labeled ‘Impact Locations’). The modal test grid consisted of 27 impact points that followed the geometry of the blade. This impact grid offered sufficient spatial resolution to identify and distinguish mode shapes. A threshold force window was applied to the force time history to minimize the noise on the force data outside the applied force pulse. After applying five modal impacts at each location and measuring both the impact force and response time histories corresponding to these impacts, the single-input, multiple-output frequency response functions were estimated for the five averages using the H1 algorithm to minimize the effects of noise on the response measurements. Ordinary coherence functions were also estimated to determine the quality of fit of the frequency response function models.

The multiple-input, multiple-output frequency response function data were analyzed using the Complex Mode Indicator Function, or CMIF. The CMIF is mathematically suited to identify closely spaced modal frequencies by using the singular value decomposition of the normal matrix that was produced using the matrix of frequency response function data. The results of this computation are illustrated in FIG. 3-2. The top three spectral lines of this plot were used to identify degenerate modes of vibration with repeated roots and pseudo-repeated roots. At frequencies shared by these three spectral lines, multiple roots are said to exist. One of the more dominant modes was identified at 8.59 Hz for which there were three roots corresponding to this single mode of vibration; consequently, there were three modal deflection shapes associated with this mode of vibration.

Table 3-1 provides a summary of the damped natural frequencies represented by each peak and multiple peaks found in the CMIF plot. The mode at 8.59 Hz is a first bending mode with a large magnitude of response as seen in FIG. 3-2.

TABLE 3-1
Summary of turbine modes of vibration identified using CMIF

| ωd (Hz) | Mode Shape Description |
|---|---|
| 3.13 | 1^{st} bending - Asymmetric bending + slight blade torsion |
| | w/hub rocking |
| 7.03 | 1^{st} bending - Asymmetric bending w/one blade in 1^{st} bending |
| (2 roots) | and other blades bending w/hub rocking |
| 7.81 | 1^{st} bending - All roots w/asymmetric blade motion w/different |
| (2 roots) | phase on each root, slight rocking of hub |
| 8.59 | 1^{st} bending - Asymmetric bending, no rocking of hub. Two blades |
| (3 roots) | bend in phase and the third blade is out of phase |
| 13.67 | 1^{st} bending - Asymmetric bending + slight blade torsion w/hub |
| | motion in and out of rotor plane in phase with bend |
| 18.75 | 1^{st} bending - Asymmetric bending w/hub rocking. Two blades bend |
| (3 roots) | in phase and the third blade is out of phase. |
| 20.31 | 1^{st} bending - Pseudo repeated root of 18.75 Hz |
| 22.27 | 1^{st} bending - Asymmetric bending w/hub motion in and out of rotor |
| (2 roots) | plane |
| 24.61 | 1^{st} bending - Asymmetric bending w/blade torsion |

To better categorize the free response behavior, the mode shapes were animated and the behavior of each mode shape was observed. The descriptions provided in Table 3-1 were based on the animation. FIG. 3-3 shows the three modal deflection shapes associated with the damped natural frequency near 8.6 Hz (3 roots). These deflection shapes illustrate the phase difference between blades in the modal deflections for the case of a repeated root. FIGS. 3-3(a) and (b) exhibit first bending with two blades bending in phase and the third blade bending out of phase. It is believed this mode of vibration and its associated deflection patterns are related to the asymmetric loading that is experienced during operation such as during horizontal or vertical wind shear inflow conditions. FIG. 3-3(c) exhibits symmetric bending in which all three blades move in phase. This mode shape is often called an umbrella mode.

Accelerometer measurement data will contain some level of random noise. To improve the accuracy with which the time and frequency data can be analyzed, various embodiments include time-synchronous averaging. Blocks of time-sampled data are synchronized using the optical tachometer pulses so that they each begin at the same angular position of the rotor to eliminate the randomness associated with the differences in phase of the blocks of data that are averaged. Components of the signal that are synchronized with the trigger, which is the optical tachometer pulse in this case, are retained, while random noise is averaged out. A block size of three rotations of the rotor is used throughout this analysis so that the averaged time history is long enough to achieve sufficient frequency resolution, which is equal to the inverse of the time history length. However, yet other embodiments of the present invention are not so constrained, and include a block size comprising a single rotation, and yet other embodiments do not include any time-synchronous averaging. As one example, some embodiments utilize low pass, high pass, and band pass filters to eliminate unwanted signal content.

Further, it is recognized that the synchronous capture of material (by which information is placed in the order domain) can be based on various representations of a complete revolution of the hub and blades. As one example, for purposes of synchronization a once per revolution signal can be acquired from an inertial sensor 50 mounted to a blade. As another example, a revolution can be determined by the repetitive voltage signal produced by the generator of the wind turbine. As yet another example, a revolution of the hub and blades can be established by a magnetic pick-up or Hall effect sensor that is responsive to rotation of the electrical machinery (including gear box), or by a photocell that measures the reflection of a light source (such as a laser) reflecting from a rotating surface.

In order to generate frequency response functions (FRFs) from the accelerometer data that is acquired from the rotor blades, operational modal analysis (OMA) is applied in some embodiments. Two assumptions in using OMA are: (1) the power spectrum of the input force is broadband and smooth, i.e. has no poles or zeroes in the frequency range of interest, and (2) the forcing function is spatially distributed in a uniform manner. Assumption (1) may not particularly applicable to wind-excited structures because the power spectrum of wind is generally dominated by low-frequency components. In general, rotating machinery is self-excited at harmonics of the operating speed, and these harmonics are seen in the OMA frequency response functions that are measured from the turbine that was tested. Assumption (2) is reasonable for a rotating wind turbine, and the measured wind planes in FIG. 2-8 and FIG. 2-9 demonstrate the spatial uniformity of the wind speed across the rotor disk inlet. However, it is understood that neither of these two assumptions are required in some embodiments of the present invention.

An OMA method 100 according to one embodiment of the present invention includes first computing the autocorrelation of the synchronously averaged time response for each channel of data. The result is two-sided, containing a positive exponential portion corresponding to the negative poles of the power spectrum, and a decaying exponential portion corresponding to the positive poles. Since both parts of the autocorrelation contain the same information, the positive exponential part is set to zero, essentially zero-padding the time signal. The resulting function is treated as an impulse response function, the discrete Fourier transform of which is the OMA frequency response function. In dynamic systems, the impulse response and frequency response functions are related through the Fourier transform in this manner.

FIG. 4-1(a) schematically describes the OMA process. FIG. 4-1(b) is a block diagram representation of a method 100 according to one embodiment of the present invention for preparing modal information about a system such as a wind turbine, preferably for use in a control and monitoring system.

Method 100 includes acquiring 110 time-based data. In some embodiments this data is synchronously averaged. Preferably, this information corresponds to motion of the blades, such as acceleration data. Method 100 can be accomplished in a variety of ways, including in the time domain, the frequency domain, or the order domain.

In some embodiments method 100 also includes removing 120 the value of the second is in (demeaning). The mean value being removed in analog fashion by use of a high pass filter on the acceleration data. However, you can also be removed mathematically from the acceleration data during signal processing within controller 90.

Method 100 further includes using a statistical method to determine the repetitive character restricts of the same. In one embodiment, autocorrelation is used for this processing. However, the present invention is not so constrained, and contemplates any method of identifying the vibratory response data corresponding to modal vibration of the blades. In some embodiments the October correlated data is processed in any manner similar to the FFT shift command of MATLAB. This command provides a symmetrical signal as seen in the upper right corner of FIG. 4-1(a).

Method 100 further includes forcing the second half of the symmetric signal 20. This time response, shown in the lower left for FIG. 4-1(A), can then be transformed by a Fourier method to produce the frequency response function shown in the lower right corner of FIG. 4-1(a).

In various embodiments the present invention include the use of modal vibratory data from a component of the system in the control of the system. Method 100 includes one manner of producing modal information. However, the present invention is not so constrained, and contemplates any manner of generating modal response data, especially in those environments where the vibrating component, such as the blades in a wind turbine, also has applied to it a reasonably steady load, as well as a fluctuating load, such as the load from a non-uniform wind pattern.

A discrete Fourier transform according to one embodiment is carried out in the order domain, which measures frequency relative to the rotational position rather than absolute time (rotations⁻¹ rather than seconds⁻¹). This order domain approach is convenient for analyzing the dynamics of rotating machinery for two reasons: 1) as stated previously, these systems are typically self-excited at harmonics of the rotational frequency, and 2) variation of the independent parameters throughout testing, such as yaw and pitch error, affects the rotational speed of the rotor; therefore, analysis in the order domain allows for comparisons to be easily made between these unequal-speed data sets. However, it is understood that the present invention contemplates application of the filtering and signal processing described herein in any of the time, frequency, or order domains.

In some embodiments, a feature 98 is extracted from the processed data to indicate a change in the parameter being studied. In practice, such features are calculated from raw data and then used by the operator to implement control or maintenance decisions. It is understood that these features can be used to close a control loop in an automatic control system. As examples, a feature 98 can represent a feedback variable, or represent a signal to be further processed into a feedback variable, or can be one of several variables used as feedback in a control system, or a variable used in feedback of automatic control system having multiple closed loops (such as inner and outer loops). Further, in some embodiments, a feature 98 is used to set logical flags in an automatic control system or an automatic monitoring system. Such flags can be used to change the mode of control of the wind turbine, or used to generate information (such as warnings) sent to operators of the wind turbine. Some examples of these features 98 that are described below.

Due to fluctuations in aerodynamic loading, yaw error 98.1 occurs in accelerometer data at a once-per-revolution frequency: 1 rot⁻¹ in the order domain. The result of integrating the OMA FRF from 0.5 to 1.5 rot⁻¹ has been shown to be an indicator of the feature yaw error 98.1, even in the presence of horizontal and vertical wind shear. For analyzing the yaw variation data, a method according to one embodiment of the present invention includes some or all of the following acts:
1) The OMA FRF is calculated, preferably for each measurement channel and preferably including the flap, lead-lag, and span directions on each blade.
2) The OMA FRFs of blade degree of freedom groups (i.e., the flap, lead-lag, and span groups) are averaged, resulting in one OMA FRF for each direction associated with the three blade degrees of freedom.
3) Each of the averaged OMA FRFs are integrated from about 0.5 to about 1.5 rot⁻¹.
4) The integration results, one for each degree of freedom, are the feature 98.1 values, x.

FIG. 4-1(c) depicts a block diagram for a method 200 according to another embodiment of the present invention. This feature 98.1 can be used for closed loop control and/or monitoring of a wind turbine system, such as system 90. Changes in this feature as a result of controlling the yaw angle of the wind turbine result in changes to the modal response of the blade being measured (or of the average of the blades, if multiple measurements are being taken). Feature 98.1 can be used in a control system according to some embodiments in order to correct the yaw angle of the turbine, and thereby capture a greater amount of energy from the wind stream. However, it is understood that the measured modal response data can be used in algorithms other than method 200 to improve the yaw angle of the wind turbine, based upon modal responses of one or more blades.

The blade flap responses couple with the fore-aft acceleration response of the nacelle, and that coupling varies depending on the pitch angle of each blade. In order to calculate a feature value 98.2 for pitch error, the following procedure is used:
1) The cross-power spectrum is calculated between each blade's de-meaned, time-synchronously averaged flap acceleration response and the fore-aft acceleration response measured on the nacelle housing. The discrete Fourier transform is preferably performed in the order domain.
2) The peak in each cross-power spectrum magnitude closest to about 1 rot⁻¹ is found.
3) The highest pitched blade has a higher magnitude of response in the cross power spectrum at 1 rot⁻¹ than the other two blades. The feature is the sum of the difference of the peak value in the pitched blade's cross power spectrum at 1 rot⁻¹ with the other two blades' peak values, normalized by the sum of the non-pitched blade's peak response. This normalization can account for relative magnitude differences due to reduced rotor speed in high pitch-angle situations. Mathematically, the feature value 98.2, x, is:

$$x = \frac{[ ( {p}_{3} - {p}_{1} ) + ( {p}_{3} - {p}_{2} ) ]}{{p}_{1} + {p}_{2}} \qquad Eq 1$$

where p₃=peak in pitched blade cross power spectrum magnitude at 1 rot⁻¹

p₁=peak in non-pitched blade one's cross power spectrum magnitude at 1 rot⁻¹

p₂=peak in non-pitched blade one's cross power spectrum magnitude at 1 rot⁻¹

FIG. 4-1(d) identifies a method 300 according to another embodiment of the present invention. Method 300 in one embodiment of the present invention prepares the value of a feature 98.2 useful in correction of pitch error. It is understood that the specific method described in FIG. 4-1(d), as well as the method described above, are but two examples of features (control system variables) useful in feedback during closed loop control of a wind turbine 90. Some embodiments of the present invention include other methods for manipulating a cross correlation between the modal response of a blade with the modal response of another blade, or with the modal response of the nacelle or other non-rotating structure of the wind turbine.

For damage detection in some embodiments, the time-synchronously averaged operational response data is analyzed in the frequency domain. The averaged linear spectra are calculated using the discrete Fourier transform. FIG. 4-2(a) shows an example of the linear spectra magnitude for the case of blade ice accretion and undamaged blades. Many of the peaks in the linear spectra occur at frequencies that correspond to the modes of vibration listed in Table 2-1. The information gleaned in the modal analysis of the rotor blades helps develop an understanding of which modes are excited during operation, and are useful in controlling the operation of the wind turbine.

Mode shape analysis is used to identify frequencies in the operational data that correspond to asymmetric bending modes such as modes at 3.1 Hz and 8.6 Hz, but any frequency with a known mode of interest can be evaluated. Trends in the dynamic response at these frequencies can be exploited to reveal a change in the rotor blade condition and how the ability to observe that condition varies with yaw angle. Various embodiments include control systems that implement a change in yaw angle or pitch angle as a result of calculations performed on the dynamic response of the frequencies of interest. Various other embodiments include control systems that set a logical flag or indicator in response to the detection of damage or ice accumulation.

To evaluate these trends in one embodiment, the mode (frequency) of interest selected in the processed operating frequency spectra and the maximum value of the magnitude of the DC acceleration is recorded for a single degree of freedom for each blade within the frequency band. This procedure is carried out for each minute of the 10 min data set and the 10 values are averaged to provide one value for each blade at each yaw angle. The FIGS. 4.2 below illustrate the frequency banding process, where the frequency of interest is 3.1 Hz. The linear spectra are then bound from 2 to 4 Hz and the maximum acceleration value is found for each blade on this interval.

The magnitude of the acceleration for each blade is used to compare the change in response due to a damage condition and a yaw angle in various wind regimes. In the case of blade root damage, the responses of the blades are compared by finding the difference in response between blade pairs, such as when one blade experiences a reduction in stiffness at the root boundary condition. The reduction in stiffness should cause a change in operational response of this blade and is measured against the healthy blades. For this damage case, the difference in response between healthy and unhealthy blades should, therefore, be greater than the difference between healthy blades.

In some embodiments of the present invention, there is a feature 98.3 (also useful as a variable used in a control system) which is an indicia of the health of the blade (such as whether or not there is any damage present). In some embodiments, the magnitudes of modal responses at a particular mode of interest are compared among the blades during operation. In comparing the magnitude of a modal response among blades, some embodiments include identifying the damaged blade as the blade having the greatest magnitude of response, relative to the other two blades. In yet other embodiments, the damage may also be identified by a blade that has the greatest relative difference in phase angle relative to the other blades. In yet other embodiments, the magnitude of response (or relative phase angles) are compared to baseline data, especially baseline data that includes historical data, including historical trends. In still further embodiments, the damaged blade may be identified by the width of the magnitude of response, such as by identifying the width of the half-power points in a power spectrum, which can indicate a damaged blade by its greater width, and higher damping during operation.

For the case of ice accretion, the magnitude of acceleration is used to track changes in operating response of each blade at a particular frequency of interest and to prepare a feature (or control system variable) 98.4. In some embodiments, a record is made (such as by the electronic controller) of the response of the blades, especially when new, for subsequent use as a baseline for comparison. The magnitude of the response when ice is present on the rotor blades is compared to the magnitude of the response for un-iced blades by calculating the percent error between a historical baseline response and the iced blade response.

As best seen in the bottom of FIG. 4-2(b), the appearance of ice on each of the blades results in a shift of a resonant mode around 3 Hz to a slightly lower frequency. This is best seen with regards to blade 2. Further, the appearance of ice on a blade can also result in a reduction in the magnitude of dynamic response, as best seen with regards to blade 3. Therefore, control systems according to some embodiments of the present invention compare modal frequencies of a blade under current operating conditions to a stored modal response for that blade. A downward shift in frequency, especially one coupled with measurement of ambient temperatures indicating freezing conditions, can lead in some embodiments to the setting of a flag in the software to indicate that ice may be present. This logical detection for ice accumulation can be further buttressed by a comparison of the magnitude of response, to see if the current magnitude is lower than a historical baseline.

FIG. 4-1(f) shows a method 500 according to one embodiment of the present invention for detection of ice on a blade using modal information about the blade. Method of 500 is similar to method 400, except the accumulation of ice can be detected as a downward shift in the frequency of a blade mode of vibration.

A block diagram of a control system according to one embodiment of the present invention is shown in FIG. 1-2(b). The system 90 shown in this figure includes an electronic controller 80 that is operatively connected to a wind turbine 30 that produces electrical power Z. In some embodiments, wind turbine 30 includes a pitch control actuator 33 and a yaw control actuator 37. At least one blade 32 of the wind turbine includes a motion sensor 50. However, as described herein, wind turbine 30 can include a plurality of motion sensors 50, such as one for each blade or multiple sensors for one or more blades. Further, it is understood that there are other sensors on wind turbine 30 not shown in FIG. 1.2(b) that provide information back to controller 80. The sensors include sensors for wind speed, rotor speed, rotor position, electrical voltage generated by the generators, ambient temperature, gear box temperature, and others.

Controller 80 includes an input section 82 that includes the hardware and software 82 that performs signal processing on sensors 50. In some embodiments, signal processing software 82 includes method 100 for identifying modal information about the blades 32 during operation of wind turbine 30. However, it is understood that input software 82 further includes various types of analog and digital filtering, and that the output of software 82 includes multiple parameters provided to signal processor 84, including frequency response functions, real time data, peak magnitudes of selected modes, phase information about selected modes, and the like. The various information gleaned from sensors of the wind turbine are provided to signal processing software 84. Processing software 84 further receives external commands X from the operator, other wind turbines, or the like.

Signal processing software 84 receives inputs from both modal identification software 82 and from the operator. These inputs are further processed. Preferably one or more control variables 98 are provided as outputs to control software 86. It is understood that although reference is being made to different sections of software, such categorization is for explanation only, and is not indicative of any requirements on the software. Any of the various signal processing methods described in this document can be performed anywhere within the software of controller 80, or further, in certain cases, in analog circuitry of controller 80.

As examples of signal processing software 84, in some embodiments there is software performing some or all of the functions of method 500. In such embodiments a flag Y can be set and sent to the operator for his attention. In yet other embodiments, the output of this software can be used later in one or more control algorithms of actuator controller 86.

In one embodiment, signal processing software includes some or all of methods 200, 300, and 400, as described herein. It is appreciated that the descriptions of these methods are not restrictive in nature, and these methods can be expressed in many different software codings.

In various embodiments, control variables 98.1, 98.2, and 98.3, are prepared and provided to controller 86. Generally, variables 98.1, 98.2, and 98.3 are representative of numbers related to blade pitch, power optimization, damage detection, and the like. It is understood that the features 98 previously discussed can be directly used in feedback control (such as being provided to a summing junction), or used in the preparation of one or more variables provided to a summing junction. It is further noted that the reference to a summing junction is indicative of a number used in feedback control, and does not have to represent digital or analog summation. Instead, these features 98 include information in them that is used in control of the wind turbine 30.

Further processing of control variables 98.1, 98.2, and 98.3 is performed in control software 86 by, as examples, software modules 299, 399, or 499, respectively. It is in these software modules that the control variable or feature 98 is used to prepare the command signals that appear as outputs to pitch actuator 33 or yaw actuator 37. It is understood that various types of closed loop controls are envisioned. As one example, controller 80 implements a proportional-integral control methodology and state-space terms. As another example, controller 80 implements command signals to actuators 33 and 37 in terms of a proportional-integral-derivative controller implemented in classical control theory. Various embodiments of the present invention are not restricted to any particular manner of closing the loop to provide stable operation of wind turbine 30.

Statistical analysis is applied in some embodiments to determine how variations in the wind load affect the sensitivity to yaw or pitch error and the sensitivity to rotor damage/condition. The feature 98, x, is normalized in some embodiments to obtain its standard score according to

$$\frac{x - μ}{σ} \qquad Eq 2$$

where ρ and σ are the estimated mean and standard deviation of x, respectively. The standard score is how many standard deviations x is above or below its mean. Because Equation 3 is normalized by σ, changes in x are more readily detected when the feature has little variance for a given operating condition. If x is assumed to be equal to μ±3σ, then the level of change in x from the mean value corresponds to a 99% confidence interval, i.e. the analyst is 99% certain that the feature has undergone a biased change even in the presence of natural variations in x. When this value of x is substituted into Equation 1 and then normalized, the following result is obtained,

$$\vert \frac{x}{μ} - 1 \vert = \frac{3 σ}{μ} \qquad Eq 3$$

expressing how much of a shift in x is required to detect a statistically helpful change in the feature mean with 99% confidence. For example, if x in the flap direction for yaw error exhibits a alp of 0.02, then a 6% change in x (3*0.02) is required useful to achieve 99% confidence that a change due to yaw error has occurred. Therefore, the result of Equation 2 represents a measurement of the sensitivity of x: if it is small, then the sensitivity is high, and that is desirable in terms of condition monitoring because it means that even amidst variations in wind loading and other factors, a change in x indicates a change in the feature.

The yaw error feature is calculated in each of the blade degrees of freedom for the three different wind conditions. These feature values are first plotted versus the yaw error angle to produce one curve for each wind condition and rotor blade measurement degree of freedom in FIG. 5-1, FIG. 5-3, and FIG. 5-5. Each of these figures has an accompanying sensitivity curve, which is a plot of the percent change in the feature that can be used to detect yaw error with 99% confidence, which is equivalent to 3σx/μx. A low value on these curves indicates a high sensitivity of the feature at that particular yaw error and wind plane shear condition. For instance, in FIG. 5-2, the value on the vertical shear sensitivity curve at +10° yaw error is 5%, while the value on the no-shear sensitivity curve is 15%. Thus, it can be said that under a vertically sheared wind profile, only a 5% change in the feature, x, from its mean value is required used to detect a yaw error of +10°, but under a uniform wind velocity distribution, a 15% change in the mean value of the feature is used to detect the same +10° yaw error. It is recognized that any of the FIGS. 5-X provide data that is useful in preparing yet other control variables 98 that are useful in any of the control modes described herein.

Several aspects in the presence of yaw error can be extracted from the plots of the flap measurement degree of freedom response and sensitivity seen in FIG. 5-1 and FIG. 5-2.

The power extracted from the wind in the test cases involving wind shear is lower than the corresponding case involving no wind shear (refer to FIG. 5-1). FIG. 5-1 shows that the yaw error feature 98.1 is symmetric about 0° yaw error for the uniform (no-shear) wind condition, whereas the vertical and horizontal wind shears produce asymmetric curves. Asymmetry can be helpful from a controls standpoint because each yaw error can then be associated with one or more feature values 98. For instance, if the wind turbine is in a uniform flow and the normalized flap response feature value is 0.5, the yaw error could be either +5° or −10°. If, however, the wind profile is characterized by vertical shear, that same normalized feature value of 0.5 would indicate approximately a +8° yaw error.

It is observed that wind shear does not hinder but rather enhances the ability to detect yaw error. This increase in sensitivity in the presence of wind shear is seen in FIG. 5-2 because the wind shear curves are somewhat smaller in magnitude and, therefore, somewhat larger in sensitivity. One reason why wind shear does not interfere with the feature calculation may be that it tends to affect the 3 rot⁻¹ blade dynamics; therefore, it does not affect the integration of the OMA FRF over the 0.5 to 1.5 rot⁻¹ range.

Under horizontal wind shear the sensitivity decreases (the % change in x used to detect a change in the feature value with 99% confidence increases) as the turbine is yawed into the side of the inlet plane with higher velocity wind (positive yaw error). Horizontal wind shear can be particularly prevalent in wind farms due to the presence of wake flows from upstream turbine rotors, which produce velocity deficits on downstream turbine rotors

FIG. 5-3 shows that in the lead-lag DOF, the feature 98.1 is nearly symmetric about 0° yaw error, regardless of wind shear condition. Furthermore, FIG. 5-4 indicates that the feature sensitivity is two orders of magnitude higher in the lead-lag direction than in the flap direction of FIG. 5-2, likely because the blade undergoes relatively small deflection in the stiffer leadlag direction, and thus experiences less variation due to factors other than yaw error. So not only is the standard deviation of the lead-lag measurements lower, but a higher proportion of the variation in this direction is due to yaw error compared to the flap direction.

The span DOF exhibits similar feature curves as the lead-lag DOF in the vertical and horizontal shear conditions, but the uniform flow condition produces a nearly-flat feature curve between ±20°, which is not as desirable because it means that a wide range of yaw errors can have nearly the same feature value. Furthermore, while the feature curves are similar for the vertical and horizontal shear cases, FIG. 5-6 shows that the feature for span is more sensitive in vertical shear, especially for larger yaw errors.

A method described herein is effective at detecting pitch error 98.2 in the cases of uniform and vertical wind shear conditions, as shown in FIG. 5-7. In one embodiment, the two feature curves are nearly identical, which can be helpful in terms of control because the method is applicable regardless of whether there is uniform or vertically-sheared wind flow. Under the horizontal wind shear condition, the trend followed closely for pitch errors of 15° or higher, but was not as reliable for pitch errors of 0° and 5°, at which the feature value became negative. One possible explanation for this different behavior in horizontal wind shear is that due to the severe wind profile that was used, the cross-power spectra at the smaller pitch angles were dominated by the 3 rot⁻¹ frequency component, so the blade-to-blade differences in the dynamics at 1 rot⁻¹ were not as pronounced.

The other blade DOFs, lead-lag and span, did not exhibit as much trend in their cross power spectra with any of the nacelle DOFs. The sensitivity of the pitch feature is low for 0° and 5°, especially in the vertical and horizontal wind shear cases (see FIG. 5-8), meaning that a large change in the mean value of the feature is useful to detect low pitch errors. This occurred because for low pitch errors, the low mean value of the feature, which is near zero at zero pitch error, is on the order of the standard deviation. FIG. 5-9 shows that the sensitivity of this measurement above ten degrees pitch error is high.

By using an approach such as method 400 the change in response due to blade ice accretion was readily identified. The frequency of most interest for damage detection was found to be 3.1 Hz; therefore, damage results correspond to the change in the magnitude of acceleration in the 2 to 4 Hz frequency band of the linear spectra. In the order domain this frequency corresponds to 1 rot⁻¹ response of the turbine rotor-dynamics. Additionally, the leadlag DOF revealed the greatest sensitivity to changes in the rotor-dynamics due to ice accretion.

### 5.3.1 Detection of Ice Accretion In the Presence of Yaw Error

FIG. 5-10 shows the percent change in the magnitude of response in the edge-wise (leadlag) direction for each blade plotted vs. yaw angle. This plot reveals that ice accretion causes an increase in the edge-wise response in the case of uniform wind flow for all yaw angles. The response of Blade 3 is slightly higher but the overall change in response of each blade is appreciable. For low yaw angles the response of each blade has increased by approximately 15% to 18%. As yaw error increases the percent change in response magnitude for each blade decreases, making the ability to detect ice accretion in the presence of severe yaw error more challenging.

A similar trend is observed when operating in vertical shear flow. FIG. 5-11 illustrates that simulated ice accretion causes the edge-wise response to increase significantly for all three blades. This figure also reveals a large measure of symmetry about 0° yaw position. Similarly, the same increase in response is observed when operating in horizontal shear flow, as illustrated in FIG. 5-12. These results suggest that the damage condition can be identified regardless of the wind profile. This result is useful for the application of utility-scale wind turbines where vertical and horizontal wind shear conditions can be prominent in wind farms.

For the case of pitch error, similar results and trends observed in yaw error were revealed. FIG. 5-13 shows the percent change in the magnitude of response in the edge-wise (lead-lag) direction for each blade plotted vs. pitch angle. This plot reveals that ice accretion causes an increase in the edge-wise response of each blade across all yaw angles in the case of uniform wind flow. The response of Blade 2 is slightly lower than Blades 1 and 3; however, the overall percent change in the response of each blade exceeded 35% at low pitch angles from 0° to 5°. As pitch error increases the percent change in response magnitude for each blade decreases. For 35° pitch error the percent change in the magnitude of response for all blades coalesces near 26%. This is a favorable outcome, permitting the detection ice accretion for a range of pitch error when operating in uniform wind flow.

For the case of a turbine operating in vertical and horizontal shear regimes, the trends observed in FIG. 5-13 are prevalent. FIG. 5-14 and FIG. 5-15 show the percent change in the magnitude of response in the edge-wise (lead-lag) direction for each blade plotted vs. pitch angle when operating in vertical shear and horizontal shear, respectively. Again, the overall percent change in the response of each blade exceeded 35% at low pitch angles from 0° to 5° and for increasing pitch error the percent change in the magnitude of response of all blades coalesce near 26%. As with detection of ice accretion in the presence of yaw error, these results suggest that the damage condition can be identified regardless of the wind profile or pitch error.

In the case of blade root damage, a method described herein was applied and revealed that the flap degree of freedom near 7 Hz emphasized the change in response due to the damage condition. In the order domain this frequency corresponds to 2 rot⁻¹ dynamics of the turbine. Recalling FIG. 2-9, the rotor experiences a 2 rot⁻¹ oscillation in wind speed as it moves through one full rotation. At this rotational frequency the reduced stiffness in the root of the blade is somewhat sensitive to the 2 rot⁻¹ fluctuations in the flap DOF; therefore damage results in some embodiments correspond to the change in the magnitude of acceleration between blades at this order.

FIG. 5-16 shows the change in blade-to-blade response ratio for varying yaw error when operating in a uniform wind flow. The damaged blade (Blade 3) causes the blue and green curves to exhibit the largest changes whereas there is negligible change near zero yaw error for the undamaged blade-to-blade response ratio (red curve). The undamaged blade-to-blade response ratio exhibits symmetry about zero yaw with a slight increase in response due to the change in yaw position near −10° and 15°. FIG. 5-17 shows a similar trend for the blade-to-blade response ratio when operating under vertical wind shear. In this wind regime the 2 rot⁻¹ dynamics are more pronounced due to the shear profile. Again, the blue and green curves exhibit the largest changes whereas there is negligible change for the undamaged blade-to-blade response ratio (red curve). Similar traits are observed in FIG. 5-18 for a turbine operating under horizontal wind shear. However, the curves now increase for negative yaw error and the undamaged blade-to-blade response (red curve) has lost the symmetry about zero yaw, but does maintain an appreciably smaller magnitude when compared to the blade-to-blade response ratio with damage present. A negative yaw error for horizontal wind shear the rotor plane is oriented in an increased wind flow and therefore experiences an increase in response for negative yaw error. The increased blade-to-blade response ratio for negative yaw error is an artifact of the horizontal wind shear and yaw position combined. The blade-to-blade response ratio method identifies root damage in the presence of yaw error. One aspect of this method is that no historical baseline response data is needed to make these comparisons to determine if damage is present.

Trends are observed in the blade-to-blade response ratios to identify damage in the presence of changing pitch angle. The change in response amplitude for the blade pairs with the damaged blade (Blade 3) increased significantly beyond a 15° pitch angle. The blade-to-blade response ratios were plotted for the case of no damage and only the pitch angle of Blade 3 was altered. FIG. 5-19 shows the results of this plot. The figure reveals that for pitch angles from 0° to 15° the change in the blade-to-blade response ratios for all blade pairs is negligible; i.e. damage is not present. However, for pitch angles beyond 15° the blade-to-blade response ratios for the blade pairs with the pitched blade (Blade 3) increases significantly. This demonstrates a sensitivity to determine damage in the presence of pitch angles beyond 15°. This observation is exemplified in FIG. 5-20. This figure shows the change in blade-to-blade response ratio for increased pitch error when operating in a uniform wind flow. The damaged blade (Blade 3) causes the blue and green curves to exhibit change. At pitch angles greater than 15° the change in the blade-to-blade response ratio is dominated by the change in pitch angle of Blade 3. FIG. 5-21 shows a similar trend for the blade-to-blade response ratio when operating under vertical wind shear and in FIG. 5-22 for a turbine operating under horizontal wind shear. Again, the blue and green curves exhibit changes. Although what has been shown and described the use of real-time modal identification in the control of a wind turbine, various embodiments of the present invention are not so constrained. The methods and apparatus described here in our applicable to many different systems, especially those systems in which there is a component that vibrates relative to the rest of the system, and the modal response of that component can be beneficially change by the real-time repositioning of that component, or yet another component, relative to the system.

As one example, the system can be a ship, such as a submarine. As the ship moves in the water and is subjected to wave motion or tidal motion, some component or subsystem of the ship may have a vibratory response to the unsteady or non-uniform excitation presented by the water surrounding the ship. In such cases it may be possible to change the vibratory response of the component or subsystem by use of the writer, or in the case of a submarine, the diving planes. This is because the particular component or subsystem was sensitive to the forcing function, and the movement of the writer or diving planes may be able to alter the environment of the component or subsystem, such that the modal response is beneficially change.

In yet another embodiment the system can be a rocket having engines that produce thrust and which are actually edible to different positions, or different levels of thrust. As the engine thrust changes, the entire vehicle, or a component or subsystem, will respond in one of its vibratory modes. In such cases, it is possible to alter the thrust vector of the engine, or change the angle of a control Finn, so as to provide a compensatory input to the vehicle, component, or subsystem, that provides a beneficial change in the modal response.

In a still further embodiment the system can be a spacecraft having one or more components that are deployable, or having engines used in control of the attitude of the spacecraft. As these components are deployed, or as the engines generate brief periods of thrust, one or more systems or components of the spacecraft will respond with a vibration in one of its modes. In such cases, it is possible to identify the modal response, and implement a beneficial change in that modal response, by use of an actuator on the spacecraft. This compensating actuator may be the same engines or another engine, or an electromechanical actuator such as a piezoelectric actuator mounted to the spacecraft.

Various aspects of different embodiments of the present invention are expressed in paragraphs X1, X2, X3, X4, and X5, as follows:

X1. One aspect of the present invention pertains to a method for control of a wind turbine. The method preferably includes providing a wind turbine including a plurality of blades coupled to a rotatable hub, a plurality of sensors, each blade having at least one sensor, and a controller receiving a signal from each of the sensors. The method preferably includes measuring the signals by the controller during operation of the wind turbine, and determining a modal response of at least one blade. The method preferably includes modifying operation of the wind turbine at least in part to change the modal response.

X2. Another aspect of the present invention pertains to a method for control of a wind turbine with blades. The method preferably includes providing a control system for the wind turbine and a sensor attached to at least one of the blades, the sensor providing a signal corresponding to the vibratory response of the blade. The method preferably includes removing the mean value of the signal and identifying a blade vibratory mode from the demeaned signal. The method preferably includes preparing a variable for the control system and using the variable in control of the wind turbine, the value of the variable being at least partly dependent upon a characteristic of the vibratory mode.

X3. Another aspect of the present invention pertains to a method for control of a wind turbine with a non-rotating structure and blades. The method preferably includes providing a control system for the wind turbine, a first sensor attached to a blade and providing a first signal corresponding to the vibratory response of the blade, and a second sensor attached to non-rotating structure of the wind turbine and providing a second signal corresponding to the vibratory response of the non-rotating structure. The method preferably includes cross-correlating the first signal and the second signal, and preparing a variable for use in the control system, the value of the variable being at least partly dependent upon the cross-correlating.

X4. Another aspect of the present invention pertains to a method for control of a wind turbine having a plurality of blades. The method preferably includes providing a control system for the wind turbine, a sensor attached to each blade and providing a signal corresponding to the vibratory response of the blade. The method preferably includes converting into the frequency domain each of the plurality of signals. The method preferably includes comparing the frequency content of each blade to the frequency content of each other blade. The method preferably includes automatically controlling the wind turbine based on comparing.

X5. A method for controlling a mechanical system, including providing a mechanical system including a plurality of components, an actuator for changing the orientation of a first component relative to a second component, the system being mechanically excited by a non-uniform forcing function, a sensor for providing a signal responsive to the motion of one of the first component or the second component, and a controller receiving the signal and providing commands to the actuator. In some embodiments the method includes identifying in real-time a modal response of one of the first component or the second component. The method can also include determining by the controller a change in the orientation that modifies the modal response. Preferably, the method also includes commanding the actuator by the controller to implement the change.

Yet other embodiments pertain to any of the previous statements X1, X2, X3, X4 or X5, which are combined with one or more of the following other aspects:

Wherein the hub can be yawed relative to the earth modifying includes changing the yaw angle of the hub.

Wherein the blades are coupled to the hub by a pitch control actuator, and modifying includes changing the pitch angle of at least one blade.

Wherein modifying includes identifying a condition of the wind turbine to an operator.

Wherein the condition is ice on a blade, damage to a blade, or load on a blade.

Which further comprises statistically comparing a signal before determining.

Wherein statically comparing includes an autocorrelation of the signal.

Wherein statistically comparing includes cross-correlating the signal with another signal.

Wherein the sensors each provide a signal responsive to at least one of strain, stress, displacement, velocity, or acceleration of the blade.

Wherein the modal response is one of the flap, lead-lag, or span modes.

Wherein determining is in the order domain, frequency domain, or time domain.

Wherein modifying includes a control algorithm having a control loop closed with a characteristic of the modal response.

Wherein the characteristic is a magnitude of the response, phase angle of the response, frequency of the response, or includes a comparison of the modal response with another modal response.

Wherein the characteristic is an integration of the response.

Wherein the vibratory mode is the current vibratory mode, which further comprises providing a historical baseline of the vibratory mode, and preparing includes comparing the current vibratory mode to the baseline vibratory mode.

Which further comprises integrating the blade vibratory mode, and the characteristic is the integrated value.

Wherein the sensor has at least two axes of providing two signals, recording is recording of each signal, removing the mean value is for each signal, and identifying includes averaging the two signals for the mode.

Wherein recording is of the time-domain response of the blade, or the frequency-domain response of the blade.

Wherein recording is for a single complete revolution the wind turbine, or a synchronous average over multiple revolutions of the wind turbine.

Wherein wind turbine generates electricity at a frequency corresponding to revolution of the wind turbine, and which further comprises using the frequency to synchronize recording.

Which further comprises preparing an autocorrelation of the signal before identifying.

Which further comprises ignoring a portion of the autocorrelated signal.

Wherein identifying is by preparing a Fourier transform of the demeaned signal.

Wherein cross-correlating includes preparing the cross-power spectrum of the first signal relative to the second signal, and the variable depends in part upon the cross-power spectrum.

Wherein the non-rotating structure is the nacelle, or the non-rotating structure is the beam supporting the nacelle.

Wherein cross-correlating includes determining a peak response.

Wherein cross-correlating is in the order domain, and the peak is proximate to once per revolution of the wind turbine

Which further comprises removing the mean value of the first recorded signal before cross-correlating.

Wherein cross-correlating includes preparing a Fourier transform of the cross-correlation.

Wherein preparing a Fourier transform is in the order domain.

Wherein the first signal corresponds to the flap response of the blade.

Wherein the second signal corresponds to the fore-aft response of the non-rotating structure.

Wherein automatically controlling includes setting a flag for the attention of the operator, or shutting down operation of the wind turbine.

Wherein comparing is in a predetermined range of frequencies.

Wherein comparing includes comparing the peak magnitude of each blade to the peak magnitude of each other blade at a predetermined frequency.

Wherein automatically controlling includes identifying the blade that has the greatest peak magnitude.

Wherein comparing includes comparing the current frequency of the peak magnitude of each blade to a predetermined frequency for each blade.

Wherein automatically controlling includes identifying an icing condition if there is a reduction in the current frequency for more than one blade.

wherein the forcing function is the wind, or a rocket engine, or waves in a body of water, or a change in the orientation of third component relative to one of the first or second components.

wherein the system is an aircraft, or a building, a ship, or a rocket, or a spacecraft.

wherein one of the components is one of a solar panel, instrument boom, or antenna

wherein the actuator is a piezoelectric actuator.

While the embodiments have been illustrated and described in detail in the drawings and foregoing description, the same is to be considered as illustrative and not restrictive in character, it being understood that only certain embodiments have been shown and described and that all changes and modifications that come within the spirit of some embodiments of the invention are desired to be protected.

1. A method for control of a wind turbine, comprising:
providing a wind turbine including a plurality of blades coupled to a rotatable hub, a plurality of sensors, each blade having at least one sensor, and a controller receiving a signal from each of the sensors;
measuring the signals by the controller during operation of the wind turbine;
determining a modal response of at least one blade; and
modifying operation of the wind turbine at least in part to change the modal response.

2. The method of claim 1 wherein the hub can be yawed relative to the earth and said modifying includes changing the yaw angle of the hub.

3. The method of claim 1 wherein the blades are coupled to the hub by a pitch control actuator, and said modifying includes changing the pitch angle of at least one blade.

4.-7. (canceled)

8. The method of claim 1 which further comprises statistically comparing a signal before said determining.

9.-10. (canceled)

11. The method of claim 1 wherein the sensors each provide a signal responsive to at least one of strain, stress, displacement, velocity, or acceleration of the blade.

12. The method of claim 1 wherein the modal response is one of the flap, lead-lag, or span modes.

13. The method of claim 1 wherein said determining is in one of the order domain, frequency domain, or time domain.

14.-15. (canceled)

16. The method of claim 1 wherein said modifying includes a control algorithm having a control loop closed with a characteristic of the modal response.

17. The method of claim 16 wherein the characteristic is one of the magnitude, phase angle, or frequency of the response.

18.-19. (canceled)

20. The method of claim 1 wherein the characteristic includes a comparison of the modal response with another modal response.

21. (canceled)

22. A method for control of a wind turbine with blades, comprising the acts of:
providing a control system for the wind turbine and a sensor attached to at least one of the blades, the sensor providing a signal corresponding to the vibratory response of the blade;
recording the signal during operation of the wind turbine;
removing the mean value of the recorded signal;
identifying a blade vibratory mode from the demeaned signal; and
preparing a variable for the control system and using the variable in control of the wind turbine, the value of the variable being at least partly dependent upon a characteristic of the vibratory mode.

23. The method of claim 22 wherein the blade is coupled to a hub, the control system includes an actuator adapted and configured for changing the yaw angle of the hub, which further comprises using the variable to automatically modify the yaw angle of the hub.

24. (canceled)

25. The method of claim 22 wherein the vibratory mode is the current vibratory mode, which further comprises providing a historical baseline of the vibratory mode, and said preparing includes comparing the current vibratory mode to the baseline vibratory mode.

26. The method of claim 22 wherein the characteristic is the magnitude of the vibratory mode.

27. The method of claim 22 wherein the characteristic is the frequency of the vibratory mode.

28. The method of claim 22 which further comprises integrating the blade vibratory mode, and the characteristic is the integrated value.

29. The method of claim 22 wherein the sensor has at least two axes of providing two signals, said recording is recording of each signal, said removing the mean value is for each signal, and said identifying includes averaging the two signals for the mode.

30.-31. (canceled)

32. The method of claim 22 wherein said recording is for a single complete revolution the wind turbine.

33.-34. (canceled)

35. The method of claim 22 wherein the sensor is an accelerometer.

36. (canceled)

37. The method of claim 22 which further comprises preparing an autocorrelation of the signal before said identifying.

38.-39. (canceled)

40. A method for control of a wind turbine with a non-rotating structure and blades, comprising the acts of:
providing a control system for the wind turbine, a first sensor attached to a blade and providing a first signal corresponding to the vibratory response of the blade, and a second sensor attached to non-rotating structure of the wind turbine and providing a second signal corresponding to the vibratory response of the non-rotating structure;
recording the first signal and the second signal during operation of the wind turbine;
cross-correlating the first signal and the second signal; and
preparing a variable for use in the control system, the value of the variable being at least partly dependent upon said cross-correlating.

41. The method of claim 40 wherein said cross-correlating includes preparing the cross-power spectrum of the first signal relative to the second signal, and the variable depends in part upon the cross-power spectrum.

42.-43. (canceled)

44. The method of claim 40 wherein said cross-correlating includes determining a peak response.

45. (canceled)

46. The method of claim 40 wherein said control system includes an actuator adapted and configured for changing the pitch angle of the blade, which further comprises using the variable to automatically modify the pitch angle of the blade.

47. The method of claim 40 which further comprises removing the mean value of the first recorded signal before said cross-correlating.

48. The method of claim 40 wherein said cross-correlating includes preparing a Fourier transform of the cross-correlation.

49. (canceled)

50. The method of claim 40 wherein the first signal corresponds to the flap response of the blade.

51.-52. (canceled)

53. A method for control of a wind turbine having a plurality of blades, comprising the acts of:
providing a control system for the wind turbine, a sensor attached to each blade and providing a signal corresponding to the vibratory response of the blade;
recording each of the plurality of signals during operation of the wind turbine;
converting into the frequency domain each of the plurality of signals;
comparing the frequency content of each blade to the frequency content of each other blade; and
automatically controlling the wind turbine at least in part based on said comparing.

54. The method of claim 53 wherein the frequency content is the current frequency content, which further comprises providing a historical baseline of the frequency content, and said preparing includes comparing the current frequency content to the baseline frequency content.

55. (canceled)

56. The method of claim 53 wherein said automatically controlling includes shutting down operation of the wind turbine.

57. The method of claim 53 wherein said comparing is in a predetermined range of frequencies.

58.-71. (canceled)
